(19) United States
(12) Patent Application Publication
(10) Pub. No.: US 2019/0392427 A1
(43) Pub. Date: Dec. 26, 2019

(54) DIGITAL TRANSACTION SYSTEM AND METHOD WITH A VIRTUAL COMPANION CARD

(71) Applicant: XARD Group Pty Ltd., Brighton, VA (US)

(72) Inventor: Robert Wilson, Brighton (AU)

(21) Appl. No.: 16/445,619

(22) Filed: Jun. 19, 2019

Related U.S. Application Data
(63) Continuation of application No. PCT/AU2017/051418, filed on Dec. 19, 2017.

(30) Foreign Application Priority Data
Dec. 19, 2016 (AU) 2016905251
Dec. 19, 2016 (AU) 2016905254

(51) Int. Cl. G06Q 20/34; G06Q 20/08

(52) U.S. Cl. CPC G06Q 20/3563; G06K 19/07709; G06Q 20/0855; G06Q 20/341

(57) ABSTRACT

A digital transaction system operable to perform at least one digital transaction with at least one digital transaction device (26, 28, 30, 32), the digital transaction system including a Digital Transaction Card (DTC) (10) including a Digital Transaction Processing Unit (DTPU), the DTPU including a software module including instruction code which, when executed, causes the DTPU to receive and implement instructions in accordance with a standard command protocol (“standard commands”); a DTC external processor; and a DTC transceiver, in which the DTPU software module is operable to receive a plurality of standard commands issued by the DTC external processor responsive to user selection of a desired DTC personality, thus causing the DTPU to adopt the user selected personality; and upon completion of execution of the plurality of standard commands, the DTC (I O) adopts the user selected personality as the personality of the DTC (10).

### CROSS REFERENCE TO RELATED APPLICATIONS

Continuation of International Application No. PCT/AU2017/051418 filed on Dec. 19, 2017. Priority is claimed from Australian Application No. 2016905251 filed on Dec. 16, 2016 and Australian Application No, 2016905254 filed on Dec. 16, 2016. All the foregoing applications are incorporated herein by reference in their entirety.

### STATEMENT REGARDING FEDERALLY SPONSORED RESEARCH OR DEVELOPMENT

Not Applicable

### NAMES OF THE PARTIES TO A JOINT RESEARCH AGREEMENT

Not Applicable

### BACKGROUND

The present invention relates generally to systems and methods for effecting digital transactions, including both financial and non-financial transactions. The system and method may be particularly useful for transactions involving credit and/or debit cards.

Credit cards, debit cards store cards and gift cards are examples of cards that are used for financial transactions throughout the world. Further, other types of cards such as passes, tags and small booklets (which may be referred to collectively as transaction documents or transaction cards) are used for various financial and non-financial transactions. For example, some jurisdictions require proof of age cards for transactions such as purchasing alcohol or entering into age restricted venues. Other examples of proof of age or proof of identity documents include driver licenses which are sometimes used for authentication in respect of transactions. In some countries, passports and/or other similar identification documents are issued in the form of a card, or a small booklet, and can be used for transactions where identification is required including, travel across borders or establishing a bank account.

Many transaction cards have a magnetic stripe, which can be encoded with information such as a unique identification number, expiry dates or other numerical or alphanumerical information. Other types of transaction cards include contactless stored value smart cards, for example, closed loop transport cards.

Transaction cards may include a chip, smart chip, or smart card chip (in this specification, such chips and other similar types of microcircuit will be referred to generally as Digital Transaction Processing Units, or DTPUs). DTPUs typically include one or more of a Central Processing Unit (CPU), Read Only Memory (ROM), Random Access Memory (RAM), Electrically Erasable Programmable Read Only Memory (EEPROM), a crypto-coprocessor and an Input/Output (I/O) system. For example, credit cards often use an EMV chip (where EMV is an abbreviation for Europay, MasterCard, and Visa). The EMV chip (or other type of DTPU) contains encrypted data relevant to the type of transaction(s) for which the document will be used. The EMV chip may be read by a scanner, for example, contactless close proximity communication such as a Near Field Communication (NFC) tag, by direct contact with chip connected electrodes, or by other means to obtain data from the chip. Such transaction cards enabled for use in digital transactions by means of a chip, a magnetic stripe, a chip and magnetic stripe, or Radio-Frequency IDentification (RFID) are referred to throughout this specification as Digital Transaction Cards (DTCs).

DTCs are configured to work with various terminals. For example, credit and debit cards work with EFTPOS (Electronic Funds Transfer at Point Of Sale) terminals for Point Of Sale (POS) transactions, and ATM (Automatic Teller Machine) terminals. Other DTCs are configured to work with other types of terminals. Such terminals may be operably connected to financial institutions or other third-party organizations to enable digital transactions to occur by authorizing the transaction or performing associated processing to enable the transaction.

In another example, identification cards, such as a proof of age cards, are implemented with a chip (or DTPU) containing some, or all, of the information of the card owner, along with verification information to confirm the authenticity of the card. Identification cards may be used in a digital transaction, whereby it is inserted into, or swiped near, a terminal to confirm the age of the person holding the card. Other non-financial transactions can be implemented in a similar manner.

Terminals used for transactions with digital transaction documents and DTCs are referred to throughout this specification as digital transaction devices. For “Card-Present” transactions, the digital transaction devices may include, for example, POS/EFTPOS terminals, ATMs, and network connected or stand-alone readers for reading other types of non-financial transaction documents. The digital transaction devices may also be suitable for “Card-Not-Present” transactions, for example, online transactions, Mail Order/Telephone Order (MOTO) transactions, and may include internet connected personal computers, smartphones, and tablets. Further, digital transaction devices include telephones used to communicate with an operator who uses, for example, a network connected terminal to enter transaction document data.

Digital transaction documents and DTCs have a unique IDentification (unique ID), typically having a number, an alphanumeric ID, or a unique name. The unique ID may be located on, or in, the DTC, for example, printed or embossed on the document. The unique ID is also typically recorded on a database, controlled, for example, by the issuer of the DTC, and accompanied by other information, such as name, address, age, and/or financial information relevant to the user/owner of the DTC. Where a DTC has a chip, an EMV chip or other type of DTPU, the unique ID is typically stored on the chip, EMV chip or DTPU, respectively.

Credit cards are typically embossed or printed with a Personal/Primary Account Number (PAN) to uniquely identify the account card holder, the card holder's name or business, and the card's expiry date on the face of a card. Previously, some types of credit card had a magnetic stripe encoding some or all of the card information.

More recently, financial transaction cards have carried a Card Verification Value (CVV) or Card Verification Code (CVC) on the magnetic stripe to make it more difficult to replicate a card for fraudulent purposes. As a consequence, a person seeking to use a card for fraudulent purposes requires possession of the card for a sufficient period of time to make a copy of the magnetic stripe in order to duplicate the card, or to read the card and manually record the card number, expiry date, and other details printed on the card. The same principle was subsequently adopted for a second CVC sometimes called Card Verification Value 2 (CVV2), which is commonly printed in the signature panel on the back of the card. The CVV2 is used primarily to help secure e-Commerce and MOTO transactions. The CVV2 is not present on the magnetic stripe.

Some credit cards also have an associated Personal Identification Number (PIN) code, which is primarily used for “Card-Present” transactions. The PIN must be kept confidential, and must be entered on secure and certified terminals to make sure that no-one can gain access to the PIN. Further, in modern credit cards, the PIN can be stored on the chip (for example, an EMV chip) in a secure, tamper resistant memory within the card.

There are two main classifications of transactions for which credit cards are used including: “Card-Not-Present” transactions, when using the Internet or MOTO; and “Card-Present” transactions, such as used with POS/EFTPOS and ATM terminals. Card-Present transactions involve EMV chip readers (including physical contact readers using electrode pins on a card and contactless readers using, for example, contactless, close proximity communications) and/or magnetic stripe readers and generally use the full 13 to 19 digit PAN and the 4-digit expiration date. Card-Not-Present transactions generally require the user to read out to an operator, or enter into a computer, the PAN and expiration date digits. In some instances, the CVC/CVV2 number is also required.

Other types of digital transaction documents or DTCs may use various forms of security, such as PINs, passwords, and the like. However, some other types of DTCs do not use such external security, and rely only upon the authenticity of the document itself, for example, using holograms and other security devices that are difficult to copy. Further, some types of non-credit card DTCs may use chips for security, including chips similar to EMV chips.

Cards (including DTCs or other digital transaction documents) may have data stolen, for example, using a Radio Frequency (RF) signal to power the card's EMV internal microprocessor and related transmitter. Generally, the card data, such as the PAN, expiration date and cardholder's name are transferred to a wireless terminal. The terminal can be a portable or stationary wireless terminal, and once near a card, uses the RF signal to energize the card to firstly, extract the card data to a memory storage device, or to online storage, such as, the cloud, and secondly, use a portable terminal in close proximity to the card to extract monies as a contactless payment (for example, a PayWave and/or tap payment, including, for example tap-and-pay, and tap-and-go), in accordance with a level of transaction that does not require any authorization. Subsequently, stolen card data can be uploaded to a duplicate a “fake card” or used in online transactions to commit fraudulent purchases. Yet another method used to steal card data for fraudulent use involves hacking into computer databases that store card data. This data is then used for transactions, and a card owner may only become aware of this when they see a statement detailing the transactions made with their card, or card data.

Card data may also be stolen by phishing scams where the card holder is tricked into entering a security code along with other card details via a fraudulent website. Phishing therefore reduces the effectiveness of security codes as an anti-fraud means.

With the emergence of e-Commerce, an increasing number of transactions are Card-Not-Present transactions. However, this type of transaction is subject to an increasing number of attacks from fraudsters.

Several solutions have been developed to address this growing fraud, including use of virtual account numbers, authentication of cardholders separately from the transaction, and use of a hardware token to authenticate the user. Another solution is for an institution, such as a bank, to send a code to the user, typically by SMS to the user's smartphone, which can then be used to authenticate a Card-Not-Present transaction. This may be referred to as an Out-Of-Band (OOB) message. Many of these solutions require expensive infrastructure changes, which merchants and users prefer to avoid.

With the increasing number of Card-Not-Present transactions, one means of conducting such transactions is the electronic wallet (e-wallet), also known as a digital wallet. An e-wallet provides users with a means to pay for purchases from enabled on-line merchants. Upon registration, a user can store their card, billing and shipping information on a site hosted by a suitable document, such as a bank, and can access that information to pay for goods or services. However, e-wallets on a contactless proximity device, such as a smartphone, do not work in a large percentage of Card-Present transactions, for example, POS/EFTPOS or ATM transactions and as a result, the market acceptance of e-wallets has been limited and is not envisaged to improve until such time that the existing installed infrastructure of POS/EFTPOS terminals and ATM's are upgraded to support contactless communications according to ISO/IEC 14443.

A user may prefer to avoid carrying around with them many of their available credit cards, debit cards, store cards, government agency cards and loyalty cards. However, a user may require an identity card, driver's license, age verification card or passport to prove their identity or to conduct certain transactions. Carrying around many individual DTCs can be very inconvenient.

One attempted solution to accommodate users carrying a large number of credit or debit cards (whilst still able to use existing transaction infrastructure) has been developed, wherein a credit card sized device includes a keyboard (or touch pad arranged as a simplified keyboard) and a small limited capability Graphical User Interface (GUI), which are used to select one card amongst a number of logical cards or personalities (a term used to describe a logical card on a physical card or DTC) stored on the card sized device (a form of DTC), and to enter data for various transactions.

Another problem that arises when attempting to accommodate multiple credit cards, debit cards or other digital transaction documents, personalities or logical cards on a single DTC are the limitations caused using proprietary or standardized chips. Such chips, or DTPUs, are configured to securely store information for one digital transaction document only. For example, a credit card chip, such as an EMVCo standard chip, securely holds information typically including the credit card PAN, the expiry date, a security code (such as the CCV2 number), and a PIN. Transaction devices, such as POS/EFTPOS terminals, securely communicate with the DTPU to obtain some, or all, of the information from the DTPU for a transaction to be authorized and verified. Many DTPUs are also configured to resist attempts to write to the DTPU's secure record memory (which may also be referred to as a secure element, or part of a secure element), as many such attempts are made by those seeking to use the card fraudulently. A secure element may include secure memory and an execution environment, and is a dynamic environment in which application code and application data can be securely stored and administered. Further, in a secure element, secure execution of an application can occur. A secure element may be in a highly secure crypto chip (otherwise known as a smart card chip). The security of the DTPU may also prevent legitimately introducing one or more new digital transaction documents or personalities (including PANs, tokens expiry dates, PINs and other data attributes of those documents) into the secure record memory (secure element) of the DTPU to ensure that the DTPU cannot take on another document's personality.

Accordingly, it has been difficult to instigate use of a single physical card including a DTPU for the purpose of effecting transactions according to a range of multiple personalities (multiple credit and/or debit cards expressed or expressible on a single physical card), in view of the change in infrastructure required, including modified DTPUs (the requirement to create a modified DTPU (based upon a certified DTPU such as the EMVCo chip), modified digital transaction devices (for example, modified POS/EFTPOS terminals), along with any other modification required in other parts of the credit/debit card payment infrastructure. The substantial size and existing investment in the currently installed infrastructure causes substantial resistance to any change that requires further investment.

In this regard, it is desirable to provide a single EMV (or EMV type chip), or other type of DTPU, on a Digital Transaction Card (DTC), for example, a credit card sized card, which is able to selectively assume the personality of a number of different digital transaction documents (or logical digital transaction documents). For example, a user may seek to use MasterCard for one transaction, but to use Visa for a different transaction. Alternatively, a user may seek to use the DTC as a credit card, but to subsequently use it as an age identity card.

However, to-date, there has not been a sufficiently effective, efficient, and/or secure means and/or method for adapting a DTPU (such as devices according with the current EMVCo scheme) to embody different personalities as compared with the personality of the DTPU that was initially installed.

Since the certification process for a DTPU (such as an EMVCo specified device) is an extremely long and complicated process, it is particularly desirable to provide a Digital Transaction Card (DTC) that is operable to selectively assume the personality of a number of different digital transaction documents without requiring any change or modification to a DTPU device that has already achieved certification for use in accordance with digital transaction systems. A Digital Transaction Card (DTC) that is operable to selectively assume the personality of a number of different digital transaction documents without requiring any change to the DTPU that has previously been certified for use in digital transaction networks, enables the development of a DTC that comprises the desirable features of selectively assuming the personality of one of a number of different digital transaction documents without the usual delay associated with obtaining certification of a new DTPU that is operable to effect the additional functionality of the DTC that was not previously available.

Another problem with present digital transaction documents is the ability to obtain data from a credit card or other transaction document. Although devices such as EMV chips have been introduced in an attempt to limit data theft, such arrangements have not proved to be entirely successful in preventing this type of crime. Increasing credit card fraud may incur cost for a bank, a merchant, a user or all three parties. Further, identity theft is an increasing concern for users since a stolen identity can be used to commit fraudulent financial transactions, and other types of crime.

For some DTCs, such as credit cards, tokens are sometimes used to enhance security for transactions. For credit cards, tokens are typically numbers that are the same length as the credit card's PAN, and are substituted for the PAN in a transaction. The security of the token is based primarily on the infeasibility of determining the original PAN (or other data) whilst knowing only the surrogate token value. Tokenization may be used instead of, or in conjunction with, other encryption techniques in transactions with digital transaction documents.

Tokens have a number of problems, including not being selectable by the user to allow the user control over security and how tokens are used. Another problem is that the same token may need to be used for a number of different transactions, thus limiting the security afforded by the token.

One way to prevent fraudulent use of a stolen or compromised physical credit cards or other types of transaction document is to simply cancel the document, including cancelation of that document's unique identifier (for example, cancelling the account number of a credit card), and issue a new document with a new expiration date. Providers of the document may have a mechanism to invalidate old documents (for example, invalidating old account numbers), and to issue new numbers to existing users. However, it can sometimes take weeks to deliver a new document (for example, delivering a credit card through the mail), and the delay greatly inconveniences the user and causes a temporary cessation of the user's ability to maintain payments by auto debit from credit accounts. As previously mentioned regarding the issuance of tokens to provide assurance that a digital transaction is secure, or a digital transaction document cannot be fraudulently used by a third party, the existing digital transaction system infrastructure requires the issuance of a new credit card in the event that the security of an existing card has been compromised. Whilst it is possible for a bank or credit card issuer to deactivate an existing credit card and issue a new replacement card to a user, the delay in providing same causes substantial inconvenience and temporary cessation of the user's ability to conduct digital transactions. Further complicating this situation, if a user prefers to use a wearable device (such as a watch or piece of jewellery such as a ring) as their digital transaction card, the process of deactivating a card and issuing a replacement card becomes complicated.

Currently, when credit card details have been compromised and are open to fraudulent use, the accounts associated with the credit cards are deactivated and users are invited to destroy existing cards and are issued with new replacement cards. Of course, in the event a user has elected to use a wearable device as the means by which they effect digital transactions, it is not reasonable in that circumstance to require the user to destroy the wearable device with which the user conducts digital transactions.

Further, at the present time, banks and credit card issuers cannot determine the payment method used in respect of any particular transaction and although a retailer who has collected credit card details may have data compromised by an online attack, the bank and credit card provider are required to deactivate the entire account and all details associated with the credit cards whereas it may only be necessary to alter or amend the credit card details associated with one particular payment method (e.g. magnetic stripe, direct contact with EMV chip or NFC).

It is an object of the present invention to overcome, or at least ameliorate, at least one of the above-mentioned problems in the prior art, and/or to provide at least a useful alternative to prior art devices, systems and/or methods.

### SUMMARY OF THE INVENTION

In one aspect, the present invention provides a digital transaction system operable to perform at least one digital transaction with at least one digital transaction device, the digital transaction system including a Digital Transaction Card (DTC) including a Digital Transaction Processing Unit (DTPU), the DTPU including a software module including instruction code which, when executed, causes the DTPU to receive and implement instructions in accordance with a standard command protocol (“standard commands”); a DTC external processor; and a DTC transceiver, in which the DTPU software module is operable to receive a plurality of standard commands issued by the DTC external processor responsive to user selection of a desired DTC personality, thus causing the DTPU to adopt the user selected personality; and upon completion of execution of the plurality of standard commands, the DTC adopts the user selected personality as the personality of the DTC.

In another aspect, the present invention provides a method for operating a digital transaction system, the digital transaction system operable to perform at least one digital transaction with at least one digital transaction device, the digital transaction system including a Digital Transaction Card (DTC) including; a Digital Transaction Processing Unit (DTPU), the DTPU including a software module including instruction code which, when executed, causes the DTPU to receive and implement instructions in accordance with a standard command protocol (“standard commands”); a DTC external processor; and a DTC transceiver, the method including issuance of a plurality of standard commands from the DTC external processor to the DTPU responsive to user selection of a desired DTC personality; the plurality of standard commands causing the DTPU to activate the user selected personality; and the DTC thereby adopting the user selected DTC personality and being operable for use in a digital transaction network to effect transactions as the user selected DTC personality.

In yet another aspect, the present invention provides A Digital Transaction Card (DTC) for use in a digital transaction system, the DTC including a Digital Transaction Processing Unit (DTPU), the DTPU including a software module including instruction code which, when executed, causes the DTPU operating system to receive and implement commands in accordance with a standard command protocol (standard commands”); a DTC external processor; and a DTC transceiver, in which the DTPU software module is operable to receive a plurality of standard commands issued by the DTC external processor responsive to user selection of a desired DTC personality, thus causing the DTPU to adopt the user selected personality; and upon completion of execution of the plurality of standard commands, the DTC adopts the user selected personality as the personality of the DTC.

In yet a further aspect, the present invention provides a digital transaction system operable to perform at least one digital transaction with at least one digital transaction device, the digital transaction system including a Digital Transaction Card (DTC), including a Digital Transaction Processing Unit (DTPU), the DTPU including a software module having instruction code which, when executed, causes the DTPU operating system to receive and implement commands in accordance with a standard command structure (“standard commands”); a DTC external processor; a DTC transceiver; and a DTC user interface, in which the DTC external processor has received data pertaining to a plurality of separate DTC personalities; and stored the plurality of personalities in DTPU storage memory; and; the DTPU software module is operable to receive a plurality of standard commands issued by the DTC external processor responsive to user selection of a desired personality using the DTC user interface, causing the DTPU to activate the user selected personality; and upon completion of execution of the plurality of standard commands, the DTC adopts the user selected personality as the personality of the DTC.

In an aspect, the present invention provides a method for operating a digital transaction system, the digital transaction system operable to perform at least one digital transaction with at least one digital transaction device, the digital transaction system including a Digital Transaction Card (DTC), including a Digital Transaction Processing Unit (DTPU), the DTPU including a software module having instruction code which, when executed, causes the DTPU operating system to receive and implement commands in accordance with a standard command structure (“standard commands”) a DTC external processor, a DTC transceiver; and a DTC user interface, the method including issuance of a first plurality of standard commands to the DTPU to store data pertaining to a plurality of separate DTC personalities in DTPU storage memory, issuance of a second plurality of standard commands from the DTC external processor to the DTPU responsive to user selection of a desired DTC personality using the DTC user interface, the second plurality of standard commands causing the DTPU to activate the user selected personality, the DTC thereby adopting the user selected DTC personality and being operable for use in a digital transaction network to effect transactions as the user selected DTC personality.

In another aspect, the present invention provides a Digital Transaction Card (DTC) for use in a digital transaction system, the DTC including a Digital Transaction Processing Unit (DTPU), the DTPU including a software module having instruction code which, when executed, causes the DTPU operating system to receive and implement commands according with a standard command structure (“standard commands”), a DTC external processor; a DTC transceiver; and a DTC user interface, in which the DTC external processor has received data pertaining to a plurality of separate DTC personalities and stored the plurality of personalities in DTPU storage memory; and; the DTPU software module is operable to receive a plurality of standard commands issued by the DTC external processor responsive to user selection of a desired personality using the DTC user interface, causing the DTPU to activate the user selected personality; and upon completion of execution of the plurality of standard commands, the DTC adopts the user selected personality defined for the DTC.

In yet another aspect, the present invention provides a method wherein a user receives a Digital Transaction Card (DTC) from an issuing authority for use in accordance with any one or more of the statements above regarding a system and/or method.

In another aspect, the present invention provides a method wherein an issuing authority issues a Digital Transaction Card (DTC) in accordance with any one or more of the statements above regarding a system and/or method.

In yet a further aspect, the present invention provides a method wherein an issuing authority issues operating code, including software and/or firmware, for a Data Assistance Device (DAD) and/or for a Digital Transaction Card (DTC) for use in accordance with any one or more of the statements above regarding a system and/or method.

### SUMMARY OF EMBODIMENT(S) OF THE INVENTION

It is desirable to effect an arrangement for communication between a DTC and an external third party to communicate details of data stored within a DTC. It is further desirable for an external third party to have access to a facility to access and amend data stored on a DTC and in particular, amend the necessary data on a DTC to disable a compromised credit card or other digital transaction document that is open to fraudulent use and by amending data stored on the DTC, re-activate the compromised digital transaction document with new details that have not been compromised and hence are not subject to fraudulent use.

In embodiments, the standard command protocol is the Global Platform Standard (GPS).

In an embodiment, DTC personalities which are available for user selection are stored in an external third-party system.

In other embodiments, the DTC operates with one or more Modified Mobile Payment Cards (MMPCs). In such embodiments, an MMPC is a file or set of files containing data representing a personality for a payment card (a digital transaction document for payments). For example, one MMPC may represent a Visa credit card, another MMPC may represent a MasterCard debit card.

Standard Mobile Payment Cards (MPCs), sometimes referred to as virtual cards, may be issued by Trusted Service Managers or Wallet Service Providers. These MPCs or virtual cards generally do not have a real PAN and there is effectively only a single number identifying the card. Accordingly, in some instances, only a tokenised number is issued. It will be appreciated by the skilled reader that an MPC is operable only for contactless transactions (as effected by, for example, a smartphone or other mobile payment device), however, an MPC is not operable for contact transactions (as effected by, for example, standard EMV chipped credit or debit cards).

In embodiments, a TSM, or other similar third-party entity, may be configured to issue MPCs which have been modified to be installed on a DTC, and, more-particularly, to be installed on the DTPU (or EMV) of a DTC. In embodiments, the modification of an MPC includes altering the MPC to be operable for both contact and contactless digital transactions. The MPC may then be referred to as a Modified Mobile Payment Card (MMPC). An MMPC installed on the DTC (on to the EMV chip) allows the DTC to effect both contact and contactless transactions, similarly to a standard credit or debit card operating with a standard EMV chip.

In embodiments, the DTC is operable to store a plurality of MMPCs, each of which can be selected by the user to be the operable MMPC, such that the DTC operates with the personality associated with the selected MMPC.

In some embodiments, the DTC is able to operate with non-payment cards (non-payment digital transaction documents, such as loyalty cards, passports, age verification cards, and the like. Such non-payment cards are represented on the DTC by a file or set of files (virtual cards) containing data representing the personality of the non-payment card. Typically, non-payment cards are not stored, loaded or installed onto a DTPU, such as an EMV chip, but are stored elsewhere on the DTC, for example, in secure memory.

In embodiments, particularly for payment cards and MMPCs, when adopting a personality, the personality is made active, and included in a PSE and/or PPSE listing. In some embodiments, personalities (MMPCs, for payment cards) are installed on the DTPU (this is sometimes referred to as storing on the DTPU).

In another embodiment, the digital transaction system further includes a Data Assistance Device (DAD) having access to data in the third-party system pertaining to a plurality of DTC personalities (or MMPCs, for payment cards), the DAD including DAD user interface; a DAD processor; and a DAD transceiver, in which the external third-party system and the DAD are operable to transfer data from the third-party system to the DAD; the DAD and the DTC are operable to transfer data from the DAD to the DTC; and the DTPU software module is operable to receive the plurality of standard commands issued by the DTC external processor responsive to user selection of the desired DTC personality (or MMPC, for a payment card) by using the DAD user interface.

In various embodiments, the DTC is configured to enable a user to effect personality changes on the DTC without requiring connection or linking to a secondary device (for example, a Data Assistance Device (DAD) such as a smartphone). Instead, the DTC is enabled to effect changes to the DTPU (for example, and EMV chip) to cause the EMV to adopt a personality or a new personality using facilities located on the DTC itself, including the DTC external processor. In some embodiments, the DTC external processor is a Micro Controller Unit (MCU), and is loaded with firm ware and/or software configured to control the DTPU in accordance with a command protocol, such as Global Platform Standard (GPS).

In embodiments, the DTC is enabled to effect a connection with an external third party using devices such as EFTPOS/POS terminals, ATMs, or suitably secured computer devices, such as a PC operating in a bank branch, along with being enabled to effect connection with a DAD, such as a smartphone.

In some embodiments, the DTC requires connection to an external third party or a DAD when effecting a limited range of transactions, for example, when obtaining a newly-issued personality (or MMPC, for a payment card) from a card issuer. The DTC may also require data and operational software or firmware from an external third party other than the data associated with a newly-issued personality (or MMPC, for a payment card), and the DTC may be operational to be connected to the third party to obtain such data.

In some embodiments, the DTC includes two or more DTPUs, wherein each DTPU is operable to allow loading of one or more files representing a personality (or MMPC, for a payment card). In such embodiments, each DTPU is operable to perform digital transactions with the respective personality when that personality is selected. In other such embodiments, each DTPU is operable to allow loading of one or more files representing more than one personality, wherein each DTPU is operable to perform digital transactions with the respective personality when that personality is selected.

In one embodiment, the present invention provides a digital transaction system operable to perform at least one digital transaction with at least one digital transaction device, the digital transaction including a Digital Transaction Card (DTC), including a Digital Transaction Processing Unit (DTPU), and a DTC transceiver, a Data Assistance Device (DAD), including a DAD user interface, a DAD transceiver, and the DAD having access to data pertaining to a plurality of DTC personalities (or MMPCs, for payment cards), wherein an external third party system and the DAD are operable to transfer data from the third party system to the DAD and the DAD and DTC are also operable to transfer data from the DAD to the DTC, wherein the DTPU includes a software module having instruction code which, when executed, causes the DTPU to receive and implement instructions according with the Global Platform Standard (GPS), the DTPU software module operable to receive a plurality of GPS commands issued by the DTC external processor responsive to user selection of a desired personality using the DAD user interface, thus causing the DTPU to adopt the user selected personality and upon completion of execution of the plurality of GPS commands, the DTC operable to effect transactions as the user selected personality.

In an embodiment, the user selected personality (or MMPC, for a payment card) is communicated to the DTC by the DAD. In another embodiment, the DTPU seeks a data transfer from the DAD which includes the user selection.

In another embodiment, the present invention provides a method for operating a digital transaction system, the digital transaction system operable to perform at least one digital transaction with at least one digital transaction device, the digital transaction system including a Digital Transaction Card (DTC), having at least a Digital Transaction Processing Unit (DTPU), and a DTC transceiver, the system further including a Data Assistance Device (DAD), having at least a DAD user interface, a DAD transceiver and having access to data pertaining to a plurality of DTC personalities (or MMPCs, for payment cards), wherein an external third party system and the DAD are enabled to transfer data from the third party system to the DAD and the DAD and DTC are also operable to transfer data from the DAD to the DTC, wherein the DTPU includes a software module having instruction code which, when executed, causes the DTPU operating system to receive and implement instructions according with the Global Platform Standard (GPS), the method including issuance of a plurality of GPS commands from the DTC external processor to the DTPU responsive to user selection of a desired DTC personality using the DAD user interface, the plurality of GPS commands causing the DTPU to activate the user selected personality, the DTC thereby adopting the user selected DTC personality and being operable for use in a digital transaction network to effect transactions as the user selected DTC personality.

In another embodiment, the present invention provides a Digital Transaction Card (DTC) for use in a digital transaction system, the DTC having a Digital Transaction Processing Unit (DTPU), and a DTC transceiver, the DTC operable to communicate with a Data Assistance Device (DAD) having at least a DAD user interface, a DAD processor, a DAD transceiver and the DAD having access to data pertaining to a plurality of DTC personalities (or MMPCs, for payment cards), wherein an external third party system and the DAD are operable to transfer data from the third party system to the DAD and the DAD and DTC are operable to transfer data from the DAD to the DTC, the DTPU including a software module having instruction code which, when executed, causes the DTPU operating system to receive and implement instructions according with the Global Platform Standard (GPS), the DTPU software module operable to receive a plurality of GPS commands issued by the DTC external processor responsive to user selection of a desired personality using the DAD user interface, thus causing the DTPU to adopt the user selected personality and upon completion of execution of the plurality of GPS commands, the DTC operable to effect transactions as the user selected personality.

In an embodiment, the system further includes a Data Assistance Device (DAD), the DAD including at least a DAD user interface; a DAD processor; and a DAD transceiver, in which the DAD is operable to receive data from an external third party; the DTC and DAD are enabled to transfer data from the DAD to the DTC; and the transfer of data from the DAD to the DTC is effected by the DAD processor and the DTC external processor and respective transceivers.

In another embodiment, the system further includes a Data Assistance Device (DAD), including a DAD user interface; a DAD processor; and a DAD transceiver, in which method the DAD is operable to receive data from an external third party; the DTC and DAD are enabled to transfer data from the DAD to the DTC; and the transfer of data from the DAD to the DTC is effected by the DAD processor and the DTC external processor and respective transceivers.

In yet another embodiment, the DTC is operable to receive data from a Data Assistance Device (DAD), the DAD including a DAD user interface; a DAD processor; and a DAD transceiver, in which the DAD is operable to receive data from an external third party, the DTC and DAD are enabled to transfer data from the DAD to the DTC; and the transfer of data from the DAD to the DTC is effected by the DAD processor and the DTC external processor and respective transceivers.

In an embodiment, the external third-party system and the DAD transfer data therebetween. In another embodiment, the DAD and the DTC transfer data therebetween.

In an embodiment, rather than transferring data to the DTPU, the DAD transfers data to the DTC external processor that is incorporated within the DTC. The DTC external processor receives data from the DAD including a request for the DTC to adopt a specific personality. In this embodiment, the DAD may transfer GPS commands to the DTC external processor for on-forwarding to the DTPU or alternatively, may transfer a request for a specific personality in an alternate format to the DTC external processor which itself generates appropriate GPS commands for transmission to the DTPU to effect the request.

In embodiments, the DTC is operable to allow loading of at least one package representing a payment scheme into secure memory, and is operable to allow loading of at least one payment application associated with and operable with the at least one package into secure memory, each payment application representing a selectable personality (or MMPC, for a payment card) for the DTC. The DTC being further operable to allow each application to be personalised with data from a cardholder. In some such embodiments, the at least one package is stored in ROM of the DTPU, and the at least one payment application is stored in EPROM or EEPROM of the DTPU.

In various embodiments, the DTPU includes flash memory in which memory areas can be selectively allocated to perform as any one or more of ROM, EPROM, and EEPROM.

In some embodiments, a Data Assistance Device (DAD) and a Digital Transaction Card (DTC) operating together for a digital transaction provides at least two-factor verification (including authorization, authentication, and both authorization and authentication) for the digital transaction, the two factors being that the user (for example, someone wanting to pay for goods and/or services using a financial digital transaction) requires two items, namely, the DAD and the DTC. Accordingly, if a person has both a DAD and a DTC when seeking to conduct a digital transaction, the likelihood that the person has obtained both items by fraud, theft, or some other nefarious means is significantly reduced. For example, if the DAD is a smartphone, then it is unlikely that a person seeking to conduct a fraudulent transaction would be able to steal a legitimate DTC and the owner's smartphone when compared with the theft solely of a legitimate credit card. Further, if a person seeking to conduct a fraudulent transaction managed to steal a legitimate DTC, it would be very difficult for that person to emulate or spoof the DTC owner's smartphone, including any necessary additional hardware and/or software to operate with the DTC for a digital transaction.

In embodiments, the present invention provides a method of conducting digital transactions using a digital transaction system including a plurality of personalities (which may also be referred to as a plurality of Logical Digital Transaction Document Packets (LDTDPs), or personalities. In such embodiments, the personalities for payment cards may be associated with Modified Mobile Payment Cards (MMPCs), or MMPC profiles. In such embodiments, each personality represents a digital transaction document and including one or more of a unique IDentification (unique ID) or a token associated with the unique ID for performing a digital transaction with at least one digital transaction device, the digital transaction system further including, storage memory for personalities (or MMPCs, for payment cards), a DAD, and a DTC including, a Digital Transaction Processing Unit (DTPU), and, a secure record memory, the method including, operating the DAD to select one of the at least one stored personalities operating the DTPU to access the selected one personality thus enabling the DTC to be operable as the digital transaction document associated with the selected one personality. In embodiments, the personalities may be stored in the secure memory area of a device in the DAD and/or DTC, or, they may be stored in the memory associated with a secure application and/or combination thereof. In some embodiments the selection of a particular personality may be effected by arranging the personalities in a particular order. Alternatively, all personalities (or MMPCs, for payment cards) other than the selected personality (or MMPC, for a payment card) may be marked as inactive.

In various embodiments, the digital transaction document may be a credit card, debit card, bank account, store card, passport, identity card, age verification card, loyalty card, government agency card, driver's license, and/or various other kinds and types of digital transaction document, which would be typically implemented as cards, documents or booklets, or implemented electronically. It will be understood that in this specification the term “logical” refers to a set of characteristics for each of the digital transaction documents, and those characteristics may be in part or all contained in a personality representing the document or logical document. The characteristics may include data such as a unique ID for the digital transaction document, ownership information and expiry dates. The unique ID information may be a unique ID number. A change in the DTC affected by the DTPU from expressing one digital transaction document to expressing another digital transaction document may also be referred to as a change in the DTC personality.

In embodiments, a personality may include the unique ID and a token associated with the unique ID, the unique ID and token both associated with the digital transaction document represented by the LDTDP (or MMPC profile). In other embodiments, the personality may include only the unique ID associated with the digital transaction document. In yet other embodiments, the personality may include only the token associated with a particular unique ID, the unique ID (and, therefore, the token) associated with the digital transaction document.

In some embodiments, each of a number of digital transaction documents may be associated with a single unique ID and a single token associated with the unique ID, each of some other digital transaction documents may be associated with a single unique ID and a number of different tokens associated with the unique ID, and each of yet other digital transaction documents may not be associated with any token (in which case such a digital transaction document will be associated only with a unique ID). In these embodiments, the unique ID and/or token for a digital transaction document (or logical digital transaction document) will be contained in a personality. Where a document has a number of associated tokens, each token, or token/unique ID pair, may be in a separate personality. In embodiments, the unique ID for the digital transaction document contained in the personality may be a Personal/Primary Account Number (PAN) if the document is a credit/debit type card, or similar kinds of unique IDs, such as unique alphanumeric IDs or unique names.

It will be appreciated that a given digital transaction document may be represented by one or more personalities. For example, a digital transaction document associated only with a unique ID will be represented by a single personality including that unique ID. In this example, the personality being selected from a stored pool of personalities (or MMPCs, for payment cards) and installed to secure record memory (which may be referred to as a secure element, or a secure element area) causes the DTC to operate as the digital transaction document associated with the unique ID.

In another example, a digital transaction document associated with a unique ID and a single token may be represented by a single personality including the unique ID and the token. In this example, the personality being copied to secure record memory (secure element) causes the DTC to operate as the digital transaction document associated with the tokenized unique ID. Alternatively, a digital transaction document associated with a unique ID and a single token may be represented by two personalities, one of which includes the unique ID, the other including the token. In this alternative example, the personality including the unique ID being copied to secure record memory (secure element) causes the DTC to operate as the digital transaction document associated with the unique ID (untokenized), whereas the personality including the token associated with the unique ID being copied to secure record memory (secure element) causes the DTC to operate as the digital transaction document associated with the tokenized unique ID.

In yet another example, a digital transaction document associated with a unique ID and multiple tokens may be represented by various personalities including both the unique ID and one of the multiple tokens, or could be represented by one personality containing the unique ID, and a number of other personalities, each containing one of the multiple tokens associated with the unique ID associated with the digital transaction document represented by all the personalities, wherein the one of the personalities being copied to secure record memory causes the DTC to operate as either the digital transaction document associated with the tokenized unique ID, or the digital transaction document associated with the untokenized unique ID.

Other arrangements for the personalities may be contemplated, depending on the nature of the digital transaction document represented by the personality (or personalities).

In some embodiments, a personality may also contain further data associated with a digital transaction document, such as an expiry date for the document. It may also be desirable in some circumstances to have multiple expiry dates in a personality, for example, one expiry date for the unique ID (or for the associated digital transaction document) and another expiry date for a token associated with the unique ID. It will be understood that, where a digital transaction document has a number of associated tokens, each token may have a different expiry date, which will be contained in the respective personality.

Further, the personality for some digital transaction documents may include a commencement date, so that the period between commencement of validity and expiry of validity of the document (and/or one or more tokens associated therewith) can be controlled. For example, it may be desirable to have the digital transaction document valid for only one day if the document is a door pass or some other card or pass with a short validity requirement. Moreover, the commencement and expiry in the personality could include times as well as dates for finer control of the validity period of the digital transaction document (and/or one or more tokens associated therewith).

In other embodiments, the further data contained in a personality may include a security code associated with the unique ID of the document, and may also include a number of other different security codes associated with one or more tokens also contained in the personality. For example, where the digital transaction document is a credit card, the security codes may be Card Verification Value 2 (CVV2) security codes, or similar. In this example, the unique ID is a PAN, which has an associated CVV2 security code, and the PAN has, perhaps, five associated tokens, each token also having an associated CVV2.

In yet other embodiments, the personality may contain a Personal Identification Number (PIN) for the digital transaction document. There may be one PIN associated with the unique ID of the document, and other (different) PINs, each associated with a token. In some embodiments, the PINs could be One-Time PINs (OTPs), which expire after being used for a single transaction. In other embodiments, the PINs may have a limited period of validity, for example, expiring one week after first use.

In other embodiments, the personality may contain other data, such as name, date-of-birth, physical characteristics, and other personal data of a person who owns the digital transaction document. For example, if the digital transaction document is a passport, for certain transactions a personality containing the passport unique ID and eye color (or other biometric) of the owner may be desired for authentication and/or verification in such transactions.

The personality may be described as including, containing, wrapping or embodying a unique ID, token and/or other data. Further, the personality may be encrypted (or otherwise secured) to protect the data contained in the LDTDP. In yet other embodiments, the personality may be secured by using a public/private key infrastructure. The public and private keys may be issued by, for example, the DTC's primary issuer. Alternatively, the public and private keys may be issued by a primary issuer of a personality, for example, a credit card provider.

In some embodiments, the DTPU may include a system Input/Output (system I/O) for inputting and outputting data and/or encrypted data to and from the DTPU. The system I/O is a means by which a personality can be copied into secure record memory (secure element), allowing the DTPU to operate with the personality of the logical digital transaction document contained in the personality. The secure element could be located on one or more semi-conductor devices. It could also be located in a single device with a virtual partition, or a folder.

The DTPU may also include a processor, or Central Processing Unit (CPU), which operates to control the DPTU. Further, the DTPU may include a crypto-coprocessor for encrypting and decrypting data efficiently, thus allowing the CPU to operate more efficiently without the burden of encryption/decryption tasks. In some embodiments, the CPU and crypto-processor co-operate to decrypt (unwrap, unpack, or otherwise deal with) a selected personality, before or while being stored in secure record memory, such that the DTPU can operate with data from the personality.

The DTPU may also include various different types of memory, such as Read Only Memory (ROM), Random Access Memory (RAM), and Electrically Erasable Programmable Read Only Memory (EEPROM). In some embodiments, one of the types of memory can be used for the secure record memory (also known as a secure element). Further, one of the types of memory could be used as personality storage memory.

In some embodiments, the DTPU is an EMV chip (where EMV is an abbreviation for Europay, MasterCard, and Visa) or chip conforming to one or more EMVCo specifications. In other embodiments, the DTPU is an EMV chip (otherwise conforming to one or more EMVCo specifications), which is constructed to read a secure storage area, within the constructed EMV chip CPU storage area (memory), or within some other secure memory.

In embodiments, the CPU of the DTPU and or the CPU of the DTC is activated only after the CPU securely identifies itself to a linked DAD, such as a smartphone. In some embodiments, linking between the DAD (for example, a smartphone) and the DTC uses strong encryption for the ID and transfer of data. Links may be unique to each set (smartphone and DTC).

In embodiments, the linking between the DAD and the DTC for the purpose of transferring data from the DAD to the DTC is wireless, and may be formed using respective transceivers of the DAD and DTC. In yet other embodiments, the DTC is linkable with the DAD using a physical connection, such as a data cable. In such embodiments, the data cable may be adapted at one end to plug in to a USB port on the DAD, with the other end adapted to clamp or clip on to a part of the DTC. The DTC may have electrodes, or metal plates at or towards an edge thereof to connect with the cable when clamping or clipping the other end of the data cable to the DTC.

In various embodiments, the DAD is able to transfer data to the DTC without the formation of a direct link between the DAD and DTC. In such embodiments, the DAD is used to transfer data via the internet to a “cloud-connected” third party device; a link between the DAD and the third-party (cloud-connected) device for the data transfer can be temporary, and that link can be terminated once the data has been transferred. In another embodiment, the third party (cloud-connected) device is connected to a network (perhaps via another third party, such as a payment processor), which enables the third party (cloud-connected) device to form a link and communicate with a digital transaction device, such as a Point Of Sale/Electronic Funds Transfer at Point Of Sale (POS/EFTPOS) terminal or Automatic Teller Machine (ATM); subsequent to forming a link with the network and thence to the digital transaction device, the third party (cloud-connected) device is enabled to transfer the data previously received from the DAD to the digital transaction device. A holder of the DTC (which may be a person different from the owner and/or operator of the DAD) can take the DTC to the digital transaction device, and by insertion or placing the DTC proximal to the device (using Near Field Communication (NFC)), the DTC holder can obtain data from the digital transaction device. In this way, the data from the DAD can be transferred indirectly and asynchronously to the DTC. This indirect data communication between the DAD and the DTC can also be reversed such that the DTC indirectly and asynchronously transfers data to the DAD, perhaps using the same infrastructure of the digital transaction device, the network including the payment processor, the third-party (cloud-connected) device and the internet. It will be appreciated that the indirect and asynchronous data transfer may be useful where a first person has a DAD and wants to send data to a DTC in the control of a second person who is geographically remote from the first person. For example, a mother operating her DAD may seek to increase spending limits of a DTC operated by her son who is travelling in a foreign country.

Similarly, in various embodiments, external parties are able to transfer data to the DAD without the formation of a direct link between the external party and the DAD. In such embodiments, the external party may transfer data via the Internet to a “cloud” connected third party device and a link between the “cloud-connected” third party device and the DAD may be subsequently formed for the purpose of transferring data to the DAD. The communication link between the external party and the DAD whether direct or indirect, may be temporary and the link may be terminated once a data transfer from the external party to the DAD is complete. Similarly, the establishment of a communication link between the DAD and the DTC for the purpose of transferring data from the external party to the DTC may be formed directly and/or indirectly and may also be temporary and terminated once a data transfer is complete.

In an embodiment, external parties form a communication link with a user's DAD and transfers data that will effect an amendment to the token stored in respect of a personality. A personality's token may require updating in the event that the logical digital transaction document stored in the user's DAD has been compromised and is open to fraudulent use. In these instances, upon learning that a user's digital transaction document has been compromised, an external party can immediately transfer data to a user's DAD and when a communication link is formed between the DAD and the DTC, the token of the logical digital transaction document may be updated thereby preventing any fraudulent use of the digital transaction document. Of course, in circumstances where the DTC is not sufficiently close to a user's DAD for the purpose of establishing a communications link, the update to the logical digital transaction document token may be delayed and during that period, use of the DTC when configured with the personality of the compromised digital transaction document allows fraudulent use of the document. However, in embodiments, in order to use the DTC, the DTC must be brought into sufficiently close proximity, or take any action necessary, to form a communication link between the DAD and the DTC in order to enable the DTC to be used for a digital transaction. In this Embodiment, in the event that an updated token for the digital transaction document is required, at the time of forming the communication link between the DAD and the DTC, the token may be updated thereby preventing any use of the DTC for fraudulent purposes with the compromised token.

In alternative embodiments, during the period between downloading updated data to a user's DAD and transfer to the DTC, a compromised digital transaction document may be disabled and prevented from further use in transactions. As a result, a user will seek to form a link between their DAD and DTC to update data and thereby enable continued use of the previously compromised digital transaction document with new parameters.

In embodiments, the DTC CPU controls the data reading and re-read from the DTPU (for example, an EMV chip), and updating of the DTPU.

In embodiments, a DTC includes a wearable payment device, including payment devices that are incorporated into pieces of jewellery such as a finger ring, bangles and pendants. The DTC also includes any implantable payment device, which includes a chip with memory storage (including secure element storage) and transceiver arrangements which may also be suitably configured for subcutaneous implantation.

In other embodiments, the DAD may be a smartphone, or another suitable device, such as a fob, or key fob, which is configured to operate as a DAD. In some embodiments, the DAD may be, or may include a wearable device, such as a watch or other piece of jewellery. In this regard, some smartphones presently operate with wearable wrist (or watch-like) devices. It is envisaged that future smartphones may be wholly incorporated into a wearable device, and that the DAD can be such a device. In the circumstance that the DAD includes a smartphone operating with a wearable wrist (or watch-like) device, it will be appreciated that the wearable component may have its own unique ID, which can be used for secure linking and data transfer between the DAD and the DTC in cooperation with unique IDs, respectively, for a smart phone and the DTC.

In other embodiments, the DAD (smartphone), after securely connecting to the DTC, uploads correctly formatted data in a personality to the nominated secure storage area and then transmits an instruction to either the DTPU CPU or the DTC CPU to check if the nominated storage area contains the data in a specified format (a compliant personality). If the data meets the specified format and passes various checks, the DTPU CPU or the DTC CPU copies or moves the data (LDTDP) to a specified area (secure record memory/secure element) within the DTPU (for example, within the EMV chip). In an alternative embodiment, the personality is copied or moved to a location within a secure application. The DTPU CPU or the DTC CPU then transmits an instruction to the DTPU (EMV chip) to read the data (LDTDP) within the secure record memory and acts according to the data (express the personality as the associated digital transaction document) contained within this secure record memory (secure element). The DTPU CPU or the DTC CPU can be instructed to search for identifying headers and other data identifiers within a range of parameters before acting. In other embodiments, it is possible to copy all records of all LDTDPs to a secure element (which may be located in the DTPU or EMV chip), and to use an index to reference the selected LDTDP from those records. Copying all records in this manner reduces the requirement to write to and/or read from the memory, and therefore reduces risks of accessing that memory area, including security risks.

In some embodiments, the secure record memory (secure element) is located in the DTPU, and the personality storage memory (storage memory or a memory location) is located on the DAD. In other embodiments, the secure record memory (secure element) could be located within the CPU. Further, the personality storage memory could be located outside of the DTC, for example, as additional memory located on the DAD. It is also conceivable that the secure record memory (secure element) could be located outside of the DTPU on the DTC, however, this may be less secure than locating the secure record memory within the DTPU. In yet other embodiments, the personality storage memory could be located elsewhere other than the DAD or the DTC, and, for example, the personality storage memory could be located in a cloud based storage system, or could be located on portable memory, which can be accessed by the DAD for transfer to the DTC or a new replacement DTC in the event the DTC is lost or misplaced.

In embodiments, the DTC includes a card transceiver. In other embodiments, the DTC includes a Graphical User Interface (GUI) for displaying data associated with the digital transaction document or token associated with the selected or implemented personality, and a selection means for selecting the preferred personality of the DTC for a transaction. For example, if the logical digital transaction document is a credit card, the GUI on the DTC may display the PAN, the selected token associated with the selected personality containing the logical digital transaction document, the card brand logo, the expiry date of the credit card, and could also display a virtual or mimicked hologram of the credit card brand. In another embodiment, the DTC may only display the selected token and not the associated PAN. The DTC may also include a real hologram displayed somewhere on its surface. In an embodiment, the selection means is a touch sensitive pad on the DTC that upon touching, causes the display to detail an LDTP which may then be selected for use in a transaction. In an alternative embodiment, the selection means is pressure activated switches or touch switches that detect the touch of a user's finger. In yet another embodiment the switches are bump switches.

The DTC may also include a processor or CPU for controlling operations external to the DTPU and/or for controlling reading/writing and other input/output operations with the DTPU via the DTPU system I/O. The DTC CPU may also accommodate security tasks external to the DTPU, and/or control the GUI. In some embodiments, the DTC may include firmware operated by the CPU of the DTC. In embodiments, the firmware on the DTC CPU may be updated and the DTC is provided with means for enabling firmware updates. The updates may include firmware that extends functionality of the DTC and any programs and/or applications running thereon. The updates may allow for correction or amendment of existing firmware functions that have been identified as faulty or sub-optimal. Other firmware updates may be for improving or extending security, or secure functioning of the DTC. The ability to update firmware may be contrasted with, for example, existing credit or debit cards using EMV chips, where there is no ability or limited ability to update the EMV firmware.

Presently, firmware is “updated” by replacement of a credit card or debit card when it expires. In the circumstances that the DTC has a relatively long operational life, for example, 5 years or more, updating firmware during the operational life of a DTC enables the functionality of the DTC to be improved or enhanced without requiring return of the DTC to the issuing authority.

In embodiments, the DTC may only form a communications link with one DAD to the exclusion of all other DADs representing a secure communications link and transmission of data between the DAD and the DTC by respective transceivers (the DTC transceiver and the DAD transceiver). In some embodiments, the link is a secure/encrypted link. In other embodiments, each DAD may be linked with multiple DTCs. However, in this embodiment, each DTC may link with only one DAD, to the exclusion of all other DADs.

In embodiments, the linking between the DTC and the DAD may be implemented by using a unique identifier for the DTC and another unique identifier for the DAD. In some embodiments, the linking of the DTC and the DAD may occur (at least partially) before the DTC is sent to a user, for example, the linking may be implemented by a DTC issuer, including a bank, a card issuing facility, a card “personalization” facility, or other type of third party institution capable of implementing a “partial-linking”. In one example, a partial linking may be implemented by the DTC issuer establishing the DTC and providing an application ready for download by a user to the user's DAD (for example, a smartphone), wherein activating the application causes the smartphone to look for, and link to, the DTC issued to the user. In other embodiments, the linking may be implemented by the user, and may occur when the user receives the DTC.

In some embodiments, the linking between the DTC and the DAD is permanent, or semi-permanent, and cannot be unlinked, or re-linked without permission and required action from, for example, one of the previously-mentioned third parties. For example, to unlink a DTC and the DAD uniquely linked to it, a unique code may be entered on the DAD and uploaded to the DTC. This will reset the DTC to a default state. In the default state, the DTC could “look” for a new specified unique identifier for a different DAD (for example, an IMEI number, or another suitable unique ID, of a smartphone). This unlinking/re-linking may be useful when the user replaces their DAD, such as a smartphone. In yet other embodiments, the linking may be temporary, and performed by the user. For example, a user may form a link a short time before an intended transaction is to occur, and, may unlink after the transaction is completed at a predefined short duration after the transaction.

In an embodiment where the DTC and the DAD are dynamically linked, and data is transferred sporadically from an external party to a DAD, (that is, linked by the user and/or external party at a chosen time), the actions of linking the DAD and DTC and selection of the desired LDTDP from those transferred from the DAD to the DTC and stored therein, most occur in a prescribed order to ensure that the DTC receives and stores the most up to date data pertaining to the LDTDP's. Further, in embodiments, the DAD does not store or move any data pertaining to operational transaction aspects of the LDTDP's to ensure that the data is only stored/saved in a single device (i.e. the DTC) and hence the DAD operates as a data conduit only.

In embodiments, in order to ensure secure communication between the DTC and the DAD, the security may be implemented by linking the transaction card and the DAD, or the security may be implemented during data transmission between the transaction card and the DAD. In other embodiments, the security may be implemented during both the linking and the data transmission.

In some embodiments, the DTC includes power source such as a battery, a rechargeable battery, or a capacitor to provide electrical power for memory storage, for example, if the card includes non-static type memory storage or, some form of powered transceiver, such a as Bluetooth™ transceiver. A battery can also be used to power the DTC to process encryption, and for changing the personality containing the digital transaction document and/or digital token expressed by the DTC by implementing changes in the personality containing the logical digital transaction document and/or the associated digital token.

In some embodiments, the DAD includes a processor, a user interface, a device transceiver and device memory. In various embodiments, the DAD may be a smartphone, computer tablet, laptop, Personal Computer (PC), fob device, or other suitable equipment capable of operating to allow a user to select a personality and transmit data representing that selected personality. The DAD may also be a custom-built device suitable for the purpose. In other embodiments, the DAD may be a wearable device, such as a smart watch, or could be enabled to operate with such a wearable device.

In an embodiment, a selection is made from the user interface of the DAD, which may include selecting from a touch activated screen, for example, on a smartphone. The touch activated screen may operate by displaying lists, drop-down lists, or other screen designs, or may employ icons on the screen. In an alternate embodiment, the user interface may be a simple display with buttons, for example, on a fob, or a key fob. Where the DAD is a PC or laptop, it may employ a screen and keyboard to provide a user interface. However, the DAD is generally preferred by users to be a portable device. On the DAD screen, a personality may be represented symbolically with an icon relevant to the associated (logical) digital transaction document, or could use names or nicknames for the personality. The names or nicknames could be assigned by the user, or a service provider.

For example, the document might be a MasterCard credit card, so that the personality associated with the MasterCard is represented on the DAD screen by a MasterCard logo. Additionally, or alternatively, the personality may be represented by a combination of icon and alphanumeric information. For example, where a MasterCard has one or more associated tokens, each token contained in a separate personality, the personality for each MasterCard token may be represented on the DAD screen by the MasterCard logo and at least a part of the respective token number.

In some embodiments, the at least one of the plurality of personalities is stored on the DAD, wherein the personality storage memory is located on the DAD. In other embodiments, the at least one of the plurality of personalities is stored in personality storage memory located on the DTC, wherein selection of a personality through the DAD is effected by an icon, name or other indicator associated with the LDTDP, although the personality is not itself stored on the DAD. In this example, the selection of the personality is communicated to the DTC by data indicating which personality has been selected, and the card implements the selected personality from its personality storage memory based on the indicative data.

In yet other embodiments, a part of each of the at least one of the plurality of personalities is stored on the DAD. Another part of each corresponding at least one personality is stored on the DTC, wherein the selection is based on the part stored on the DAD. The part of the personality selected is transmitted to the DTC, and the determination of which part of the personality matches the selected part is made on the DTC in this way, the two parts of the personality can be combined to form the whole personality, which can then be implemented by the DTC. In such an embodiment, the personality storage memory is split between the DAD and the DTC.

In an embodiment, the DAD is enabled to store and provide for selection of a personality, which is implemented as a digital transaction document on the DTC. The selection of the document associated with a personality (or selection of the personality) may occur before selection of a token associated with the personality. Where a document has only one associated token, the selection of the document may be selection of the associated token, since a further selection process is not required. In some embodiments, selection of a token automatically indicates which personality is to be selected, since the token is associated only with one document (or one personality).

In another embodiment, the user may select a personality and a predetermined token is selected based on context determined by the DAD. For example, if the DAD senses different locations, then a token can be automatically selected based on the sensed location.

In various embodiments, some digital transaction documents contained in a personality will have only one associated token and other digital transaction documents will have multiple associated tokens. It will be understood that embodiments discussed in this specification include both options, unless otherwise stated or unless the inclusion of both options results in an embodiment that is not possible to implement.

In various embodiments, identifying information in respect of a digital transaction document contained in a personality will not need to be stored in the system personality storage memory (either in the device memory or the card memory) since the token(s) stored in the system will be sufficient to identify its (their) associated digital transaction document(s). For example, where the digital transaction document is a credit card, the card number (the PAN) is not contained in the personality and instead, the tokens associated with the credit card are sufficient to identify the particular credit card. In such an example, the credit card PAN may include the typical 4 leading digits which identifies the card as being of a certain type or brand (MasterCard, Visa, etc.). In other examples, only the last 4 digits are displayed. A token for the particular credit card may have the same four leading digits, but with different remaining digits, so that the token identifies the card with which it is associated. It will be appreciated that not having a PAN, for example, contained in the respective personality and stored in the system personality storage memory (either in the DAD memory or the DTC memory) increases security for the associated digital transaction document. In such examples, only the digital token containing personalities are selected by the DAD, with the associated digital transaction document being automatically identified and selected.

In various embodiments, the digital transaction devices may include POS/EFTPOS terminals, ATMs, internet connected computers or personal computers, and other such electronic devices. The digital transaction device may also include infrastructure such as a telephone and call centre enabled for Mail Order/Telephone Order (MOTO) type transactions.

In various embodiments, The DTC may also include a switch, or a similar device, to activate linking with the DAD. In some embodiments, the respective transceivers for the DAD and the DTC may be suitable for Bluetooth™, Low Energy Bluetooth™, Wi-Fi, NFC, ANT+, or other types of contactless, or wireless communication transceivers. In other embodiments, the transceivers may require contact between the DAD and the DTC in order to transmit data, or in order to establish a link therebetween.

In an embodiment, the DTC may be adapted to express a default “null” personality, wherein the data in place of a personality containing a logical digital transaction document requiring unique identification could be a predetermined series of digits, for example, all zeros. In one example, where the logical digital transaction document represented by the personality is a credit card, the unique identification may be the credit card PAN or an associated digital token, and setting the DTC back to expressing a null personality is performed by over-writing or replacing the PAN or the associated digital token with all zeros.

In an optional embodiment, the DTC may be configured to store a personality for an associated logical digital transaction document and/or associated digital tokens for a chosen period. The period may be predetermined by the issuer of the DTC and/or issuer of the digital tokens (which may be a different issuer to that of the DTC). Alternatively, the storage period may be chosen by the user. In other variations, the period may be dynamically selectable, and could be chosen by the user for each transaction, or for each selection and storage of a single personality for an associated logical digital transaction document and/or associated digital token(s) on the DTC. In other embodiments, the storage period for the personality for an associated logical digital transaction document and/or associated digital token(s) on the DTC could be determined based on the personality selected, the transaction type, or both.

In embodiments, the DTC and the digital transaction device may interface with each other by various methods. In some embodiments, the interface may be effected by insertion of the DTC into the digital transaction device. In other embodiments, the interface between the transaction card and the transaction device may be effected by Near Field Communication (NFC), wherein the card and/or the device each have a transceiver and antenna for communication. In yet other embodiments, the DTC may include a magnetic stripe, wherein the digital transaction device includes a magnetic stripe reader. In yet other embodiments, the DAD may include a transceiver configured for communication with the digital transaction device, so that transactions can optionally be made directly through the DAD. In yet other embodiments, the DTC is configured to be inserted into a POS/EFTPOS terminal, or an ATM, and is approximately the same size as a credit/debit card.

In further embodiments, the DTC may have a magnetic stripe, and the DAD may have a magnetic stripe reader and/or writer.

In yet another embodiment, the DTPU of the DTC is configured to store/express the personality associated with only one personality containing a logical digital transaction document and associated digital token(s) at any particular time. In this regard, to change the personality in the DTPU, a user must overwrite, delete, or render inactive, a previously-stored/expressed personality containing a logical digital transaction document and its associated token(s) if there is one embodied in the DTC at that time. In another embodiment, the card may be configured to store/express more than one personality (containing a logical digital transaction document and the associated token(s) for each document) concurrently.

In another embodiment, the DTC and its DTPU may be configured to store and/or express a personality associated with a primary logical digital transaction document and its associated token(s), and one personality associated with a secondary logical digital transaction document and its associated token(s). In yet another embodiment, the DTC and its DTPU may be configured to store and/or express one personality associated with a primary logical digital transaction document and its associated token(s), and one or more personality associated with secondary logical digital transaction documents and associated token(s) for each. The personality associated with the primary logical digital transaction document (primary logical card) and its associated token(s), in some embodiments, may be stored permanently on the DTC in its DTPU, with the one, or one or more, personalities associated with secondary logical digital transaction documents (logical cards) and the associated token(s) for each being temporarily stored on the DTC in its DTPU. In yet other embodiments, the one, or one or more, personalities associated with secondary logical digital transaction documents and the associated token(s) for each may be permanently stored and/or expressed on the DTC in its DTPU and referenced by a code stored on the DAD.

In yet other embodiments, the DAD may include an e-wallet, which can be configured to operate with one or more of the personalities containing logical digital transaction documents and associated token(s) stored on the DAD. This arrangement can be used to top up funds where the associated digital transaction document is a debit card or a credit card. Further, the DAD may include functionality to allow a user to view transactions that are completed with the DTC (or by other means, such as online transactions) in real time. This may allow the user to monitor all transactions made by all personalities associated with digital transaction documents in the system (which may include a plurality of DTCs linked or linkable with the DAD) in, a single screen or with a single smartphone application. Further, the user could be shown the associated digital token that was used for a transaction. This may further allow the user to cancel, stop, pause or otherwise appropriately deal with one or more digital transaction documents if the user detects or perceives that one or more digital transaction documents have been misused or fraudulently used. The system could also be adapted to allow the user to cancel, stop, pause or otherwise appropriately deal with one or more digital transaction documents on a token-by-token basis, so that only certain tokens associated with a document are disabled, but the document is still useable with other associated tokens. The user could also cancel, stop, pause or otherwise appropriately deal with one or more logical digital transaction documents if the user seeks to limit, for example, spending, or other financial or non-financial transactions occurring with one or more logical digital transaction documents. This may also be performed on a token-by-token basis.

In another embodiment, the DAD may be enabled to send alerts to the user when a transaction, or a selected category or type of transaction, is conducted using the DTC. For example, the DAD may alert the user that a personality containing a digital transaction document, such as a passport, has been used for identification at an airport. Further, the alerts can be implemented on a token-by-token basis. In another example, the DAD may alert the user that a credit card has been used to purchase services such as a taxi ride, not included in a list of authorized transaction categories, such as purchases of fuel and groceries, selected by the user.

In other embodiments, the DAD and/or the DTC may be configured to allow a user to classify transactions into categories. The categories could be predefined and/or defined by the user. The categorization could be configured in order to allow the user to monitor and/or limit transactions, such as spending with credit within that category. A category may be related to only one personality and associated (logical) digital transaction document, or could be related to a number of personalities and respective associated (logical) digital transaction documents. Tokens can also be used for categorization of transactions using the one personality and associated digital transaction document.

In yet another embodiment, the DAD may be configured to allow the user to transfer funds to another user who has a DAD. The transfer may be limited to same or similar personalities and associated (logical) digital transaction document types, and could be limited in amount. In a further embodiment, the DTC could be configured to transfer funds to another DTC (owned by the user or owned by another user), or to another DAD (owned by the user or another user).

Furthermore, in another embodiment, third parties, such as financial institutions, police, customs, government, employers, spouses, parents and other interested parties could be authorized and enabled to cancel, stop, pause or otherwise appropriately deal with one or more personalities containing logical digital transaction documents in the system or selected token(s) associated with the document. This may be useful, for example, if a user has a gambling addiction, and prefers to have a third-party monitor and prevent access to credit cards, debit cards, bank accounts or other kinds of financial logical digital transaction documents in order to prevent the user from excessive gambling.

In other embodiments, the DAD may be configured to store data representing loyalty points, frequent flyer points, or other associated transaction related documents, attached to a (logical) digital transaction document contained in a personality, or plurality of (logical) digital transaction documents contained in respective personalities. The DAD may also be enabled to update loyalty points, frequent flyer points and other associated transaction related documents during or after a transaction, or at other times. For example, loyalty points may be used during a transaction to reduce the cost of an item to be purchased using the DTC and the DAD. The DAD may also be enabled to add loyalty points, frequent flyer points and other associated transaction related documents if a user visits a particular shopping store, or is in a predetermined proximity of the store. In some embodiments, the loyalty points, frequent flyer points and other associated transaction related documents may be contained in a personality as further data associated with the relevant (logical) digital transaction document and/or associated tokens.

In yet another embodiment, if the DTC includes a personality containing a primary logical digital transaction document, for example, permanently stored and/or expressed on the DTC in the DTPU, the primary logical digital transaction document may be a false or fake logical digital transaction document, such that data copied from the DTC or DTPU where only the primary logical digital transaction document is stored on the DTC or DTPU will be useless for any digital transactions. Alternatively, the primary logical digital transaction document may be represented by a unique ID that is incomplete, expired or all zeros, such as a null ID. For example, where the primary digital transaction document is a credit card, the PAN of the card could be incomplete, expired or all zeros. In this embodiment, only personalities containing secondary logical digital transaction documents stored on the DTC and/or in the DTPU will be real and useable for a digital transaction when embodied on the DTC via the DTPU as a digital transaction document. Further, a personality containing a secondary logical digital transaction document and its associated digital token(s) may be stored or embodied as a tokenized digital transaction document on the DTC and/or expressed in the DTPU for only a short period, for example, five minutes, in order to reduce the risk of theft of data representing the digital transaction document and token. This arrangement reduces the risk that an unauthorized user can emulate the associated digital transaction document and token. Alternatively, the personality containing the primary logical digital transaction document stored on the DTC and/or expressed in the DTPU may comprise incomplete data, rendering the DTC/DTPU unusable for digital transactions until a user downloads and saves secondary data to the DTC/DTPU (along with associated token data), to render the primary logical digital transaction document (primary logical card) complete and useable for digital transactions.

In yet another embodiment, each of the personalities or sub-set thereof, stored on the DAD may have a PIN associated therewith (or contained therein). The PIN may be a static PIN, or could be a dynamically generated PIN. In other embodiments, the PIN may be displayed on the user interface of the DAD. Access to the PIN to display on the screen of the DAD may be by secured methods, such as finger swipe or other such security methods such as those commonly implemented on smartphones. In another embodiment, the DAD may be configured to allow the user to update a PIN for a particular personality or for a number of personalities. In embodiments, PINs could also be associated with particular tokens for a document in a personality, such that each token for the document has a different PIN. In one embodiment, when the DAD is not in close proximity with the DTC, the DTC defaults to a standard PIN. This may be required in instances where the DAD has been lost or temporarily misplaced or has temporarily lost power due to a flat battery.

In an embodiment, the method includes operating the activated DTC with the digital transaction device to perform the digital transaction.

In some embodiments, tokens are provided for a personality associated with a primary logical digital transaction document before the DTC is issued to a user. The tokens can be sent to the DAD through a secure network so that a token can be selected for a transaction with the associated personality for the logical digital transaction document (already stored on the DTC or in the DTPU at issuance) at the time of a transaction. Alternatively, the tokens associated with the primary document could be loaded onto the DTC or DTPU at issuance, with selection effected by the DAD at the time of a transaction. Secondary logical digital transaction documents (optionally contained in personalities) may be issued to the user through a secure network means to the DAD after issuance of the DTC, and the associated digital tokens for each secondary document can be issued with the associated secondary document (also optionally contained in the respective personalities).

In yet another embodiment, tokens contained in one or more personalities can be a fixed or extendible pool, which are used in a cyclical manner, with a next token selected in order. Alternatively, tokens could be selected from the pool randomly (or pseudo-randomly). In a further embodiment, tokens could be one use only, with a pool of used or expired tokens replaced when every token in the pool has been used or expired. It is also possible that the pool of tokens is replenished in advance of every token being used or expired, for example, when there are ten unused or unexpired tokens remaining in the pool, the user could be alerted to the need for token replenishment. It will be understood that single use tokens can improve security for an associated digital transaction document (and its containing personality file), and for the transactions. In another embodiment, the user could choose when to replace tokens in the token pool. In this embodiment, the user could request a new pool or an extension of their existing pool of tokens from a token provider. The new tokens could be provided already contained in respective personalities for storage in personality storage memory.

In a further embodiment, a primary user of a given digital transaction document could assign tokens to a secondary user of that document. For example, a primary credit card holder could assign token(s) from a token pool to a subsidiary holder of that credit card. This may be used as a way to control the spending of the subsidiary credit card user to limits, amounts or categories of spending.

In yet other embodiments, where tokens are assigned for usage in only certain transaction types, a third party, such as a token issuer, government agency or other controller of token usage, has authority to allow issuance of only tokens for selected transaction types. In one example, the authority controlling issuance of tokens may only allow tokens to be issued for a credit card that are for non-gambling expenditure.

In some embodiments, the tokens are generated only by a third-party (external) provider who issues the tokens to users (optionally already contained in respective personalities). The tokens may also be issued by another third-party provider in other embodiments. Alternatively, in an embodiment, the tokens may be generated locally by the user, for example, by the DAD and stored into the personality storage memory contained in personalities. The locally generated tokens could be securely copied to a third party (external party) to be matched during a transaction to thereby authorize the transaction. A cryptogram may be created containing a token, along with one or more of the associated document's unique ID, expiry date, unique ID of the DAD, time, date, location, and various other random, pseudo-random or non-random inputs. A cryptogram may also be created using, for example, a public key from the DTC, a public key from the personality (for example, if it is a credit card personality), and/or a public key from the digital transaction device (for example, a POS/EFTPOS terminal). The cryptogram may also be created using public keys from other sources. A cryptogram created using one or more public keys will contain the one or more tokens, and other IDs and data.

In embodiments, the DTC is in the form of a wearable device including a watch (smartwatch), a ring, or could be a smartphone case. With a smartphone case, all communications occur in accordance with contactless close proximity communication according ISO/IEC 14443.

In embodiments, a mobile card application may be installed onto a smartphone to effect the functionality required for the smartphone to be able to communicate with a DTC and any external third parties who seek to communicate with a DTC through a DAD in the form of a smartphone. Once installed, the smartphone displays a login screen wherein the user is required to enter identification identifying information or credentials such as a Personal Identification Number (PIN) as required on the login screen or alternatively, any secure login arrangement such as a biometric in the form of a fingerprint as displayed on the smartphone screen. Once the user has entered a valid PIN or biometric detail, the mobile card application enables the user to operate the smartphone to communicate with a DTC and/or any interested authorised external third parties.

In various embodiments, the user is requested to place their DTC in close proximity to the smartphone. In such embodiments, the DTC is in the form of a physical card and upon bringing the DTC into close proximity with the smartphone, the smartphone display indicates the current status of the DTC. The smartphone screen indicates to the user that the DTC is disabled and has a null personality.

In some other embodiments, the user operates the mobile card application and is presented with a series of screen images on their smartphone identifying the various transaction documents that the user can select for the purpose of the DTC adopting for a particular transaction. In these embodiments, the various screen images relate to a range of accounts with accompanying transaction documents belonging to the user including, a personal Visa, a business MasterCard, a home renovations account and an option to disable the DTC and render a null personality. In the particular instance of a user selecting a business MasterCard account for the purpose of conducting a transaction, a sequence of screen images would be presented to a user. In one example implementation, in the first instance, a screen image is presented to the user requesting them to place their DTC in close proximity with the smartphone such that the contactless close proximity communication capabilities of both the smartphone and the DTC may be activated for the purpose of communication therebetween. Once the DTC is brought into close proximity with the smartphone, the user selects their business MasterCard account and upon selecting that account, relevant data is communicated between the smartphone and the DTC such that the DTC adopts the personality of the user's business MasterCard at which point the DTC for all intents and purposes behaves as a MasterCard until such time as the DTC either is selected to adopt an alternate personality or a null personality to disable the card from effecting any transactions.

In another example implementation, a DTC in the form of a physical card may be activated as a business MasterCard and is used in conjunction with a merchant terminal to effect a transaction. The merchant terminal is operably connected with an acquirer who in turn may communicate with a token provider for the purpose of converting a tokenised PAN to the PAN that is recognised by the transaction network and subsequent to which communication occurs with the card issuer. In some embodiments, a screen image is displayed on a user's smartphone to confirm that a transaction has been requested. For example, a screen image confirms to the user that a transaction has been requested with the user's business MasterCard and in this particular embodiment, the user is afforded an opportunity to approve or decline the transaction.

Whilst it is possible to develop a DTPU with hardware and firmware that is adapted to enable a DTC comprising a DTPU to adopt one of many available personalities, it is preferable to achieve the same result with an existing, certified DTPU, such as a device certified in accordance with, the EMVCo specifications, without requiring any alteration to the DTPU. As will be appreciated by skilled readers, avoiding the requirement to certify a newly developed DTPU has the benefit of avoiding a substantial cost associated with the certification process and avoids the substantial delay also associated with such a process.

In the instance of credit cards, and in particular those implemented with an EMV device as the DTPU, various actions in accordance with available certified commands are implemented during the initialisation phase of a card at a fabrication facility. At that time, commands are issued to the EMV device to securely write data to the EMV secure memory thereby establishing a fixed “personality” for the card after which a security “fuse” is “blown” (the EMV chip is physically or electronically altered) to render the secure memory “read” only.

Devices such as EMV devices operating with an operating system such as the MULTOS or JavaCard systems, allow the secure execution of application software that is installed within the EMV subsystem. EMV subsystems are considered sufficiently secure to allow third party software to be installed and operated within the EMV subsystem since the operating system will prevent any inappropriate alteration of the EMV device secure memory.

Accordingly, by retaining write access to the secure memory of the EMV device, and installing application software in the EMV system that operates to receive commands that are already available according to the current EMV subsystem, further additional functionality beyond that provided by standard DTCs can be achieved. It will be recognised by skilled readers that installation of application software affords significant additional flexibility although additional functionality can be achieved solely by using the existing command set of EMV devices whereby write access to the secure memory has been retained subsequent to encapsulation and issuance of the card to a user. In the embodiment(s) described in FIG. 5 onwards, the DTPU is implemented in the form of an un-modified EMV device according to the EMVCo specifications.

In embodiments, there is a connection between an external contact plate that is provided to effect communication between transaction devices (such as EPTPOS terminals and ATM machines) and the EMV device and the connection(s) between the external contact plate and the internal contact plate that is presently included in most, if not all, digital transaction cards that include an EMV device.

In this regard, the provision of an external contact plate and an internal contact plate is an artefact of the manufacturing process for digital transaction cards that include an EMV device and in embodiments of the present invention that include both an external contact plate and an internal contact plate, the opportunity exists to route electrical connections between the external contact plate and the internal contact plate in an arrangement other than a direct one to one connection between corresponding electrodes of the external contact plate and the internal contact plate.

In an embodiment, the electrical connections accessible to digital transaction devices by way of the external contact plate are connected to an exchange and depending upon the state of the exchange, individual electrodes of the external contact plate may be electrically connected by the exchange to their counterpart electrodes of the internal contact plate.

In order to provide a direct connection between counterpart electrodes of the external contact plates and the internal contact plates, the exchange operates to connect electrodes identified (as will be understood by a skilled reader) as GND, Vcc, RST, CLK (674), I/O and the blank terminal such that all are connected respectively to their counterpart connection of the internal contact plate such that the aforementioned electrodes of the external contact plates would be connected respectively to GND, Vcc, RST, CLK, I/O and blank terminal.

Accordingly, in embodiments, when in an appropriate state, the exchange would operate to connect the individual electrodes of the external contact plate directly to their counterpart terminal of the internal contact plate which in turn are connected to the appropriate connection points of the EMV device to enable the EMV Device to operate with digital transaction devices. In this configuration, the EMV device would operate normally with digital transaction devices interfacing with individual electrodes of the external contact plate and any electrical signals applied to any one of the external contact plate electrodes, namely, GND, Vcc, RST, CLK, I/O and blank terminal would pass through the external contact plate electrode through the exchange and pass directly to the counterpart electrode of the internal contact plate namely, GND, Vcc, RST, CLK, I/O and blank terminal.

However, in embodiments where communication between a microcontroller unit and the EMV device is required, the exchange adopts an alternative state and connects the data and control signal lines of the microcontroller unit through the exchange to the individual electrodes of the internal contact plate which in turn are connected to the appropriate I/O and control lines of the EMV device. Accordingly, the exchange, in the embodiment, acts as a collection of single pole double throw switches to either connect the microcontroller unit to the electrodes of the internal contact plate and thus the relevant connections with the EMV device or alternatively, when switched to its alternate mode, the exchange disconnects any connection between the microcontroller unit and the EMV device and connects the external contact plate electrodes to the counterpart electrodes of the internal contact plates which in turn are connected to the appropriate connections of the EMV device.

Operationally, when implementing a DTC with an exchange as described above, any communication between the microcontroller unit and the EMV device would need to occur at a time that the user of the digital transaction card did not require, or attempt, a transaction with a digital transaction device such that signals were applied to the electrodes of the external contact plate. Of course, if a digital transaction was either prevented, or terminated, as a result of the exchange switching to an alternate state such that connection between the external contact plate electrodes and the relevant connection points of the EMV device were no longer present, the digital transaction would likely terminate and would fail to execute. Whilst such an outcome may be acceptable to a financial institution with which the user was attempting to conduct a digital transaction, it is unlikely that users would consider such an interruption acceptable and it is preferable that the exchange were unable to interrupt communications with a digital transaction device that is communicating with the EMV device. Further, any potential interruption to data flow in the “transaction path” of devices can lead to a requirement for the device, or component, to require re-certification. As previously mentioned, the process of re-certification of a component for operation in an electronic digital transaction network can be time consuming and expensive and is preferably avoided.

In an alternative to the embodiment, the exchange solely controls the connection of the microcontroller unit with relevant electrodes of the internal contact plates and thus relevant signal connection points of the EMV device. In this particular embodiment, the external contact plate electrodes remain directly connected to their counterpart electrodes of the internal contact plate at all times and remain connected irrespective of the state of the exchange. In this particular embodiment, the exchange acts as a series of single pole single throw switches since it is only operable to connect single lines from the microcontroller unit to electrodes of the internal contact plate and thus signal connection points of the EMV device. In this embodiment, it is necessary to consider the possibility of electrical signals being applied to the electrodes of the external contact plate during periods in which the exchange has connected the microcontroller unit to the EMV device. It will be understood by skilled readers that it is possible to employ various hardware configurations to ensure that electrical signals that could potentially damage a device are prevented from reaching the device. In an embodiment, appropriate hardware elements are employed to divert inappropriate signal energy applied to electrodes of the external contact plate such that they are prevented from transmission to the EMV device and the exchange or the microcontroller unit. An additional issue to consider is the potential for communications between the microcontroller unit and the EMV device to be monitored, and/or interfered with, as a result of connecting a device to the external control plate and in this instance, it is expected that embodiments so configured would encrypt any communications between the microcontroller unit and the EMV device to thwart any attempt to monitor, or interfere with, such communications by accessing the signals passing between the microcontroller unit and the EMV device from the external contact plate electrodes.

In yet another alternative arrangement of connection between the microcontroller unit and the EMV device wherein the exchange connects and /or disconnects selective electrodes of the external contact plate with the internal contact plate. The electrodes GND, and RST are connected to the exchange and the exchange is operable to connect those electrodes of the external contact plate with their counterpart electrodes in the internal contact plate, namely, GND and RST. Accordingly, the electrodes that are not connected to the exchange of the external contact plate include electrodes Vcc, CLK and I/O. These particular electrodes are directly connected to their counterpart electrodes in the internal contact plates, namely, Vcc, CLK and I/O and remain connected at all times. Only selected electrical connection points of the microcontroller unit are connected to the exchange for switchable connection to electrodes of the internal contact plate. The microcontroller unit has permanent connections with various electrodes of the external contact plate, namely GND, Vcc and CLK. Similarly, the I/O electrode of the external contact plate and the internal contact plate are permanently connected to each other and the serial I/O communication connection point of the microcontroller unit. Such an embodiment has the advantage of reducing attempts to monitor communications between the microcontroller unit and the EMV device by accessing electrodes of the external contact plate but suffers the disadvantage that some parts of the transaction flow are interrupted by a switchable device, namely, the exchange and hence, recertification of the device embodied in the DTC may be required.

In a further alternative embodiment, the connection between the MCU and the EMV includes an external Vcc detection circuit which acts to detect the presence of electrical power connected to external contact plate electrode Vcc which would indicate the connection of the external contact plate with a digital transaction device for the purpose of conducting a digital transaction. In this embodiment, the external contact plate electrode Vcc is connected to the microcontroller unit through an external Vcc detection circuit such that the microcontroller unit can receive a signal confirming that electrical power has been applied to external contact plate electrode thus indicating the insertion of the digital transaction card into a digital transaction device (e.g. an EFTPOS terminal or an ATM). In this embodiment, selected electrodes of the external contact plate, namely, the GND electrode and the RST electrode are connected to independent switchable devices which can connect those electrodes to either the micro controller unit or their counterpart electrodes in the internal contact plate, namely, GND electrode and RST electrode respectively. This embodiment has the advantage of providing microcontroller unit with a signal from the external Vcc detection circuit indicating that the user has elected to conduct a digital transaction and hence, the MCU can cease its communication with the EMV device in order to allow a digital transaction to be completed by the user and subsequently resuming communication between microcontroller unit and the EMV device upon detection of the absence of electrical power connected to the Vcc electrode of the external contact plate. It will be recognised by skilled readers that a Vcc Detection Circuit could be used in any embodiment to provide an indication to the microcontroller unit that power has been applied to the Vcc electrode thus indicating insertion of the DTC into a transaction device.

In yet a further embodiment, the external contact plate electrodes are directly and permanently connected to their counterpart electrodes of the internal contact plate and at the same time are permanently connected to appropriate signal lines of the microcontroller unit and the EMV device. In this particular configuration, the electrodes of the external control plate and internal contact plate are permanently connected with both the microcontroller unit and the EMV device thereby requiring any communication between the microcontroller unit and EMV device to be encrypted to thwart any attempt to monitor, or interfere with, communications between the two devices by accessing the electrodes of the external contact plate. Whilst this particular embodiment has the disadvantage of requiring encryption of all communications between the microcontroller unit and the EMV device, it does embody the advantage of avoiding any interruption to the existing transaction flow that would occur with a EMV device when taking part in a digital transaction and hence should avoid any need to re-certify the EMV device when incorporated in a Digital Transaction Card with communication effected between the microcontroller unit and the EMV device.

In yet a further alternative embodiment for effecting communication between a microcontroller unit and EMV device, the individual electrodes of the external contact plate are directly and permanently connected to their counterpart electrodes of the internal contact plate which in turn are permanently connected to the relevant electrical connection points of the EMV device. However, in order to effect communication between the microcontroller unit and the EMV device, each device is provided with its own antenna, namely, EMV device antenna and MCU controller antenna. Both the EMV device and the microcontroller unit have their own RF communications circuitry incorporated into the respective device such that each device can communicate wirelessly. In an embodiment, the EMV device and the microcontroller unit are equipped with RF communication circuitry that can be electrically attached to an antenna and can communicate in accordance with the NFC communications protocol. In this instance, the EMV device and microcontroller unit effectively communicate with each other by NFC communications conducted on the digital transaction card. Of course, in this embodiment, it is necessary to encrypt any communication between the EMV device and the microcontroller unit in order to avoid external third parties monitoring those communications by use of an NFC receiving device but as for various of the aforementioned embodiments, there is no potential interruption to the transaction flow that would usually occur between an external contact plate and an EMV device and hence, re-certification would likely be avoided with such an embodiment for effecting communications between an EMV device and a microcontroller unit incorporated in a Digital Transaction Card.

In optional embodiments, and useful for Card-Not-Present transactions, the DTC includes a display and circuitry for showing a unique CVV for each MMCP (or personality). In some embodiments, the DTC can operate with dynamic CVVs, where a unique CVV is generated for each transaction.

### BRIEF DESCRIPTION OF THE DRAWINGS

For a better understanding of the invention, and to show how it may be performed, optional embodiments thereof will now be described by way of non-limiting examples only and with reference to the accompanying drawings in which:

FIG. 1 is a diagrammatic representation of a system in accordance with an embodiment of the invention, including an external party in communication with a smartphone and a Digital Transaction Card (DTC).

FIG. 2 is a diagrammatic representation of a system in accordance with an embodiment of the invention, including an external party in communication with an Automatic Teller Machine (ATM) and the ATM in communication with a DTC;

FIG. 3 is a diagrammatic representation of a system in accordance with an embodiment of the invention, including an ATM and various digital transaction devices in communication with a DTC;

FIG. 4 is a diagrammatic representation in accordance with an embodiment of the invention, including a smartphone linked with a DTC, and the DTC operable for transactions with an ATM and various digital transaction devices;

FIG. 5 is a diagrammatic representation of a DTC in communication with a smartphone and also illustrates the selection of a digital transaction document (in this example, a credit/debit card) by use of the smartphone and selection of the personality of the DTC resulting from selection of the required personality on the smartphone and communication of same to the DTC according to an embodiment of the invention;

FIG. 6 is a diagrammatic representation of a DTC operable without a smartphone for the selection of a digital transaction document or personality (in this example, a credit/debit card) by use of a user interface on the DTC (including buttons and a screen) such that the DTC is operable with the selected personality according to an embodiment of the invention;

FIG. 7 provides a diagrammatic representation of various entities associated with the operation of a Digital Transaction Card (DTC) that is operable to adopt one of many different personalities and which also has a tokenised PAN requiring conversion to the original PAN during the processing of a transaction;

FIG. 8 is a diagrammatic representation of the elements in a DTPU according to an embodiment of the invention;

FIG. 9 is an abstract diagrammatic representation of a Digital Transaction Card (DTC) according to an embodiment of the invention in which the Digital Transaction Card (DTC) has been separated into four abstract layers for the purpose of explaining the functionality that occurs in each of the four abstract layers;

FIG. 10 is an expanded representation of the physical (electrical) layer shown in FIG. 9 and shown in FIG. 11; and,

FIG. 11 provides a diagrammatic representation of data flows between individual elements of a Digital Transaction Card (DTC) according to an embodiment of the invention, the Figures collectively providing diagrammatic support for an explanation of an exemplary data flow and interactions between individual elements on the Physical (Electrical) Layer of a Digital Transaction Card (DTC) according to an embodiment of the invention.

### DETAILED DESCRIPTION OF EMBODIMENT(S)

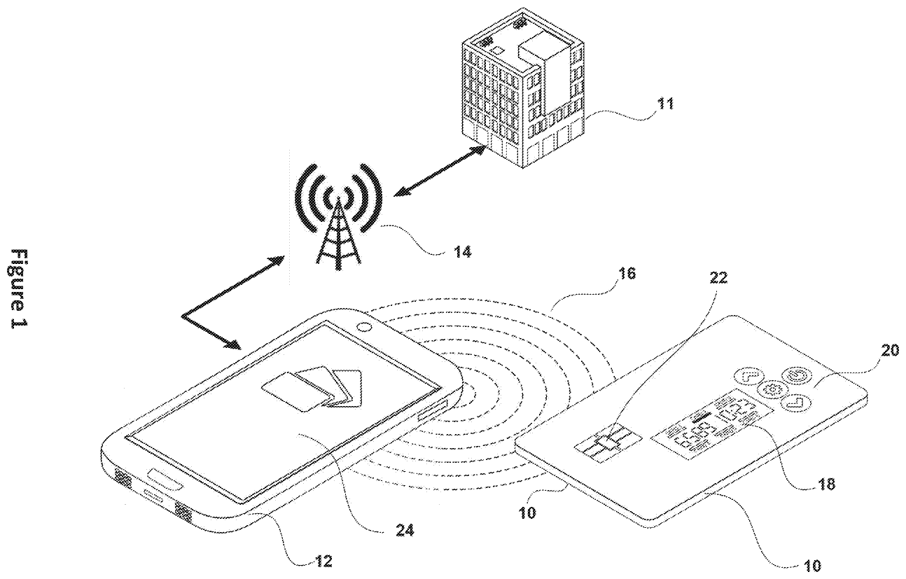

FIG. 1 details the primary components of a system according to an embodiment of the invention, including a Digital Transaction Card (DTC) (10), a Data Assistance Device (DAD) in the form of a smartphone (12) having a screen (24), an external third-party system (11). The DTC (10) also includes a digital display (18), which may be any suitable type of display for displaying details of a personality operating on a DTC, along with other information, such as transaction information. The display (18) may also be capable of showing icons, symbols and other pictorial and textual information, such as credit card logos. In embodiments, the display (18) is a low energy consumption device, including an e-paper or electronic paper display.

The DTC (10) also includes buttons (20), which may be assigned to various operations on the DTC (10). In some embodiments, the buttons (20) include any one or more of an on/off function, a scrolling function, and a selection function. In some embodiments, the DTC (10) does not require a smartphone for selection and change of personality operable on the DTC, and the user interface, including display (18) and buttons (20), may be used for the purpose of selecting and changing the personalities for the DTC.

The DTC also includes a Digital Transaction Processing Unit (DTPU), an example of which is an EMV or EMV-type chip. In embodiments, the DTPU is responsible for many functions on the DTC including control of contact and contactless transactions with digital transaction devices. In other embodiments, the DTPU is responsible for storing data representing the personality with which the DTC is operating. In other embodiments, where the DTC is operable with a selected one of a plurality of personalities, the DTPU is capable of storing all the data for each of the plurality of personalities and operating with the selected one of the plurality of personalities for contact and contactless transactions with digital transaction devices. Externally, the DTC has a contact plate (22) which is in electronic communication with the DTPU, and allows the DTPU to effect contact transactions by dipping the DTC into a digital transaction device, such as an EFTPOS terminal.

According to the embodiment illustrated in FIG. 1, the external third-party system (1) may include a financial institution that issues credit or debit cards, or a bank, or a trusted entity, who communicates with the smartphone (12) to transfer data between the external third-party system (11) and the smartphone (12). The communication between the external third-party system (11) and the smartphone (112) may occur directly, or indirectly, and may also occur as a result of a communication link being formed between the external third-party system (11) and the smartphone (12) through a third-party communication provider (14) such as a “cloud” communication gateway. In any event, the establishment of a communications link between the external third-party system (11) and the smartphone (12) enables communication between the external third party and the smartphone for the transference of data therebetween. In embodiments, the communication link is temporary and may be formed asynchronously at a time at which either the external third party (11) or the smartphone (12) requires data transfer between the two entities.

FIG. 1 also details a DTC (10) which may form a communication link (16) with the smartphone (12) to enable data transfer therebetween. Typically, a user can operate a smartphone (12) by using the screen or display (24) which is touch sensitive. In embodiments of the invention where the digital transaction document in respect of which a user seeks to conduct a transaction, the user may operate the user interface of the smartphone (12) to select a particular digital document and activate that digital document in the DTC (10). Once the DTC (10) adopts the required personality and assumes the characteristics of the digital transaction document selected by the user operating their smartphone (12) the DTC (10) may then be used to conduct transactions with the DTC (10) operating with all of the characteristics of the selected digital transaction document.

In particular, the DTC (10) with the selected personality of choice for a digital transaction document, may then be used to conduct transactions according to an existing infrastructure of a digital payment transaction network including Automatic Teller Machines, and/or merchant terminals (examples of digital transaction devices) to effect a range of transactions.

It will be appreciated by skilled readers that, even in the event the DTC is only capable of expressing a single personality, communication between an external party (11) and the DTC (10) is useful since the external third-party system (11) can obtain data from the DTC (10) that is collected and stored on the DTC (10) during transactions and/or general use of the card. Similarly, in an embodiment, the external third-party system (11) can transmit messages to the DTC display (18) by communicating the required message to the DAD (12) which in turn is communicated to the DTC (10).

Further, communication between the external third party system (11) and the smartphone (12) may occur in accordance with the existing infrastructure and communication facilities provided by smartphones and the telecommunications network that operates to enable telecommunications between smartphones and other devices and the communication between the smartphone (12) and the DTC (10) may be effected in accordance with any current communication protocol including Bluetooth and/or the contactless close proximity communication capability of a smartphone (12) and a DTC (10).

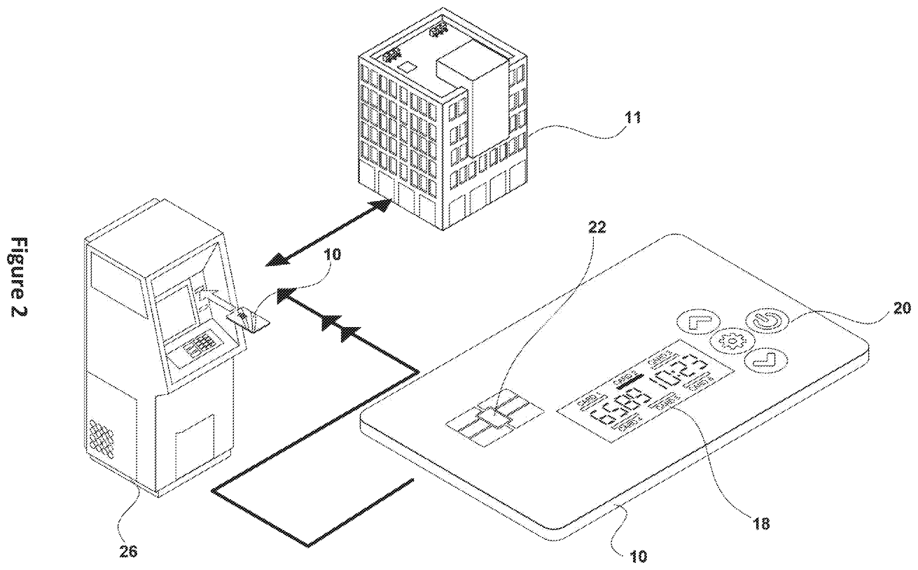

FIG. 2 illustrates and alternative embodiment in which the DTC (10) can be in communication with an external third-party system (11) through a digital transaction device in a payment network, such as an ATM (26). In such embodiments, the external third-party system (11) is in digital communication with the ATM (26) as is common infrastructure for electronic payment networks. However, in the embodiment illustrated in FIG. 2, the external third-party system (11) is also capable of transmitting data (including files, keys and other data) to the ATM (26), such that the ATM can transmit the data received from the third-party system to the DTC, when the DTC is inserted into the ATM, and such that the ATM can be operated to select and effect a change of personality on the DTC (10).

In embodiments, the DTC (10) can transmit data, for example, transaction data, through the ATM (26) to the third-party system (11).

In other embodiments, different digital transaction devices may be operable to perform the functions of the ATM (26) described above. For example, a POS or EFTPOS device may be configured to transmit data from the third-party system (including files, keys and other data) to the DTC to effect a change in personality.

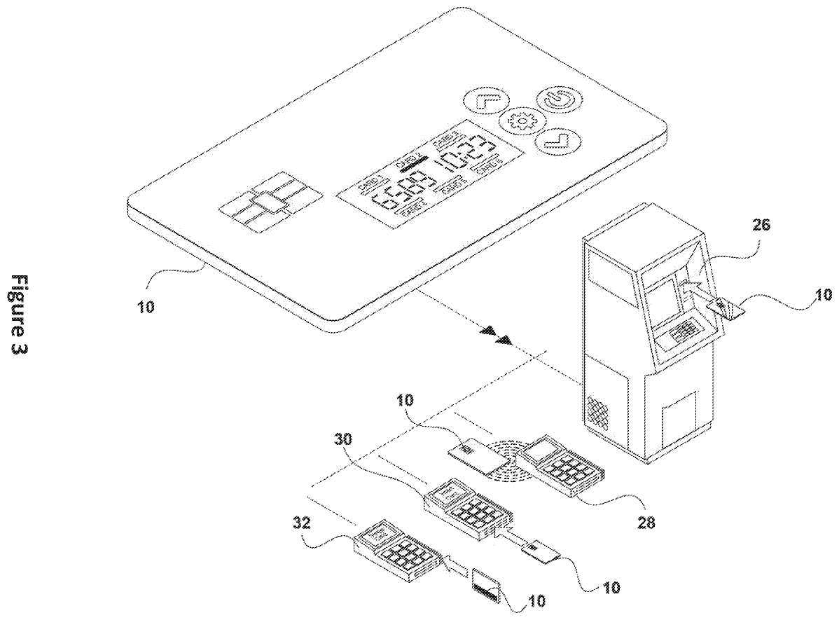

FIG. 3 shows components of a digital payment transaction system operating in accordance with current devices, communication protocols and infrastructure presently comprising such a system. For example, the components of a digital payment transaction network may comprise an ATM (26) and merchant terminals operated in accordance with a merchant terminal comprising a contactless close proximity communication capability according to ISO/IEC 14443 (28); a merchant terminal operated according to physical contact with a DTC (30), which generally includes physical contact between a payment device incorporated in the DTC (10) and electrodes resident within the merchant terminal (30); and a merchant terminal operated in accordance with a magnetic stripe (32).

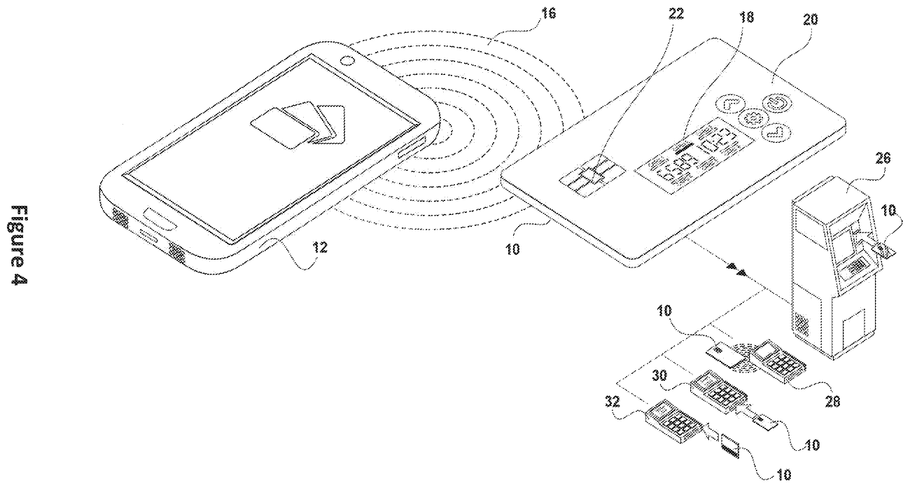

In an example use illustrated in FIG. 4, the DTC (10) is operated, for example, with a smartphone (12) to effect selection of a personality and effect change on the DTC to operate as the selected personality, the DTC operating with the selected personality is presented to any one of the ATM (26), the contactless transaction device (28), the contact transaction device (30), or the magnetic stripe transaction device (32) for a payment. The user may then choose to again change the personality with which the DTC (10) is operating for another digital transaction, perhaps with the same digital transaction device. In this way, the holder of the DTC (cardholder) may chose to effect one transaction with a Visa card, and another transaction with a Mastercard.

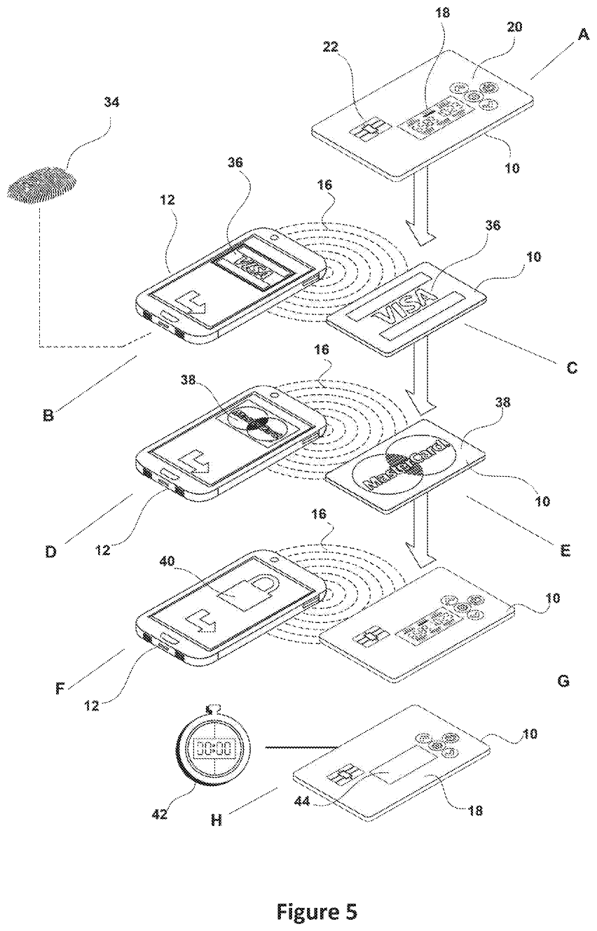

With reference to FIG. 5, a DTC in the form of a physical card or DTC (10) and a DAD in the form of the smartphone (12) is diagrammatically illustrated stepping through the process selecting a different personality for the DTC (10).

In the example of FIG. 5, the DTC (10) at step A does not have a specific personality at the point in time detailed in the diagram. At step B a user may operate a smartphone (12) and communicate with the DTC (10) in accordance with a contactless close proximity communication protocol in order to select the personality required of the DTC (10). In the particular example of FIG. 5, at step B, the smartphone (12) has executed software to present available card personalities to a user and they have elected to select a VISA card (36) as the preferred personality of the DTC (10). In an embodiment, at step B, it may be necessary for the user to provide biometric authentication such as a fingerprint (34) in order to operate the smartphone (12) to select a personality for the DTC (10).

Once the smartphone (12) communicates the user's selection of a VISA card (36) as the personality that should be adopted by the DTC (10), the relevant data is transferred from a smartphone (12) to the DTC (10) at step C and upon receipt of the data representing the personality of a VISA card (36), the DTC adopts the personality of the VISA card (36). At a subsequent point in time, the user may prefer to change the personality of the DTC to a MasterCard (38) and may operate software on their smartphone and select a MasterCard personality (38) for the purpose of effecting a personality change in the DTC (10). With reference to FIG. 5, as shown in step D, the smartphone (12) has been operated to select a MasterCard personality (38) and upon communicating the relevant personality data to the DTC (10), at step E, the DTC adopts a MasterCard personality and subsequent to which, the DTC (10) will operate as the consumer's MasterCard.

Ultimately, once a consumer has completed conducting transactions with their DTC (10), they may prefer to render the DTC with a null personality and with reference to FIG. 5, at step F, the smartphone (12) is operated to identify that the consumer prefers to lock (40) their DTC by imparting a null personality to the DTC and upon communication of the user's request, the smartphone (12) causes the DTC (10) to adopt a null personality at step G.

Another possible implementation shown at step H includes a time out indicated by representative illustration stopwatch (42), such that, when a selected amount of time has passed, the DTC (10) automatically switches off as indicated by a blank screen (44) on display (18).

In the embodiment of FIG. 5, the DTC (10) includes a modified DTPU executing software that has been modified to allow/enable the DTC to adopt different personalities including a null personality in accordance with data instructions transferred to the DTC by the DAD (12).

The modification of the DTPU software thus also allows a third party to amend data resident in the DTC (10) by communicating with the DAD (12) and issuing instructions to the DAD to amend DTC data relevant to different card personalities and wherein, the DAD transfers those instructions to the DTC to effect the data amendment instructed by the third party.

In the embodiment of FIG. 5, the communication between the DAD (12) and DTC (10) is effected by the DAD processor communicating with the DTC external processor via respective transceivers and wherein the DTC external processor having received data and instructions from the DAD, co-operatively communicates with the modified EMV device (or modified DTPU device) to cause the EMV device to adopt a required personality in accordance with the data and instructions received by the DTC from the DAD. It will be understood by skilled readers that the EMV device would no longer retain any certification that existed prior to the “modification” and hence would require re-certification as a result of the modification.

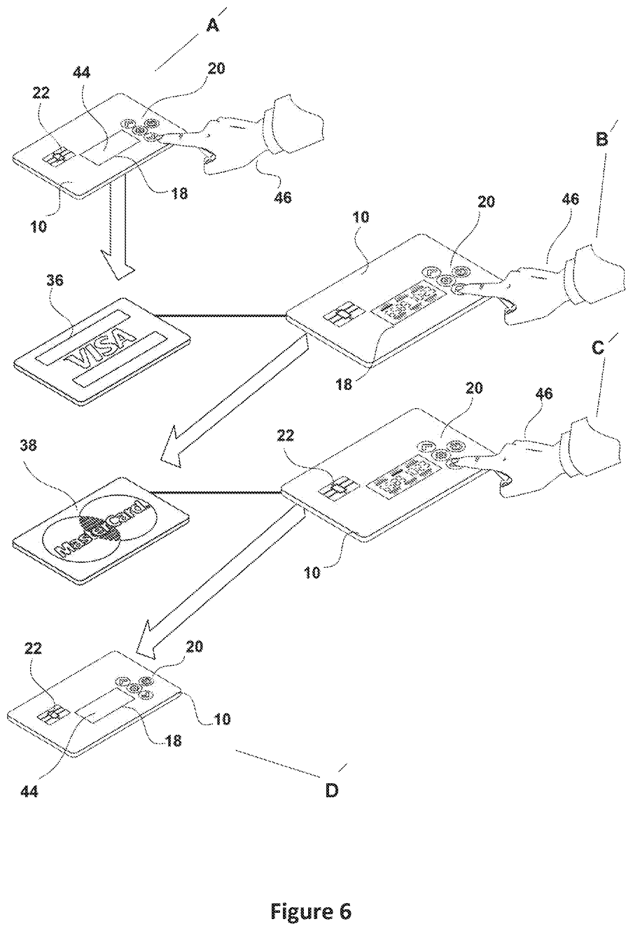

Alternatively, as shown in the example embodiment illustrated in FIG. 6, the DTC (10) can be configured to operate without requiring a smartphone (12) or any other DAD (as shown in FIG. 5) to effect a change in personality. Instead, the personality can be selected and changed by using the user interface on the DTC (10) including the display (18) and buttons (20). In such an embodiment, the DTC user can select a personality by using arrow buttons to scroll through a plurality of available personalities on the DTC (10), and selecting a desired personality by pressing cog button when the desired personality name appears on the display (18). Pressing the cog button has the effect of causing the DTC to change to the selected personality.

With reference to FIG. 6, at step A′, the DTC (10) is off or may have a null personality as indicated by blank screen (44) on the display (18). At step B′, the user scrolls through available personalities until VISA personality (36) is displayed, whereupon the user selects that personality, and the DTC (10) operates to change to that personality (36). At step C′, the user now desires a MasterCard (38) instead of the Visa card (36), so the user again scrolls through personality options using the buttons (20) until the MasterCard is displayed, and the user selects the Mastercard, and the DTC operates to change to that personality (38).

At step D′ in FIG. 6, the user no longer needs to use the DTC (10) and so selects a null personality, or turns the DTC off. In embodiments, to turn the DTC on after being in the off state requires entry of a security code.

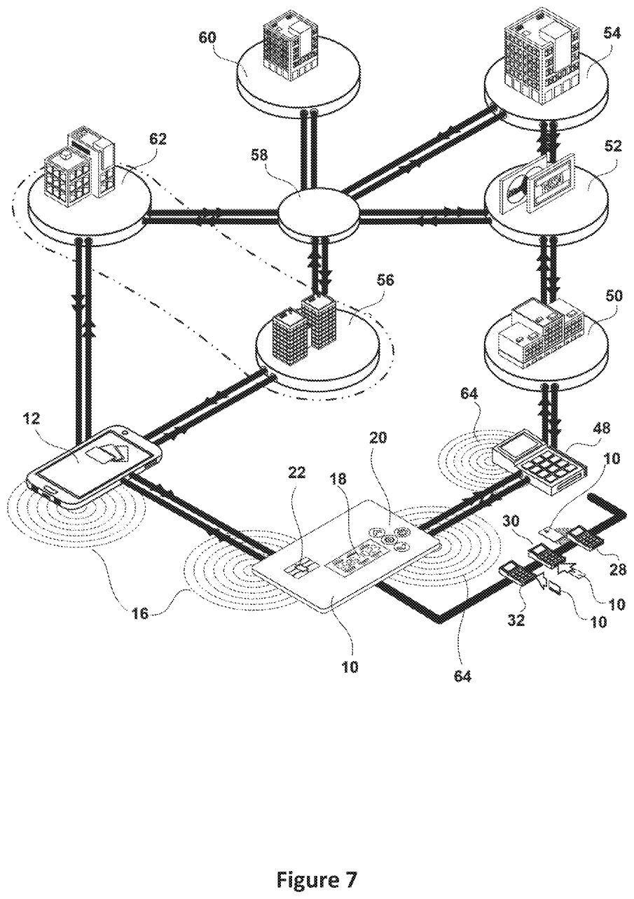

With reference to FIG. 7, a DTC (10) is detailed wherein the DTC (10) may receive commands and instructions from a smartphone (12) to effect a personality change to the DTC (10).

The DTC (10) depicted in FIG. 7 is capable of adopting one of a number of available personalities and once a particular personality has been selected and activated, the DTC (10) may be used to perform digital transactions with an existing digital transaction infrastructure including a merchant terminal (48) and may be used to conduct the transaction with existing digital transaction infrastructure according to the available modes of use of a DTC (10) with a merchant terminal (48) including use of NFC (64) capabilities (28), physical contact with the EMV contacts (30) or a magnetic stripe on the rear of the DTC (10) as depicted in operation with the merchant terminal (32).

Further, in FIG. 7, an arrangement is depicted wherein the personality adopted by the DTC (10) relates to the personality of a credit card and transactions effected by using the DTC (10) with a selected personality uses tokens to improve the security of the credit card transaction.

In this regard, in the embodiment detailed in FIG. 7, an issuer (54) initially issues the credit or debit card and creates an account for the account holder. The account is identified by a Primary Account Number (PAN) that identifies the issuer and the particular card holder account. Alternatively, the issuer (54) may issue a blank card for subsequent installation of all personalities required by the user. Further, skilled readers will also understand that the issuer (54) could also issue a card with a single MMPC (or modified virtual card) installed that is supplied by a Trusted Service Manager (TSM), which is sometimes referred to as a Trusted Service Provider (TSP). Further, in embodiments, the TSM could issue a Modified Mobile Payment Card (MMPC), which is adapted to operate for both contact and contactless digital transactions, in contrast with a standard MPC which is only operable for contactless digital transactions.

When a consumer uses their DTC (10) in a credit card transaction with a merchant terminal (48), the merchant terminal (48) interacts with an acquirer (50) and passes payment data and the token to the acquirer (50) for authorisation of the transaction.

The acquirer (50) is an entity that processes credit or debit card payments on behalf of a merchant. Effectively, the merchant acquires a credit card payment from the card issuer (54) within a payment scheme (52). The acquirer (50) exchanges funds with an issuer (54) on behalf of the merchant. With respect to the process associated with the transaction, the acquirer (50) passes the payment data and token received from the merchant to the payment scheme (52). The payment scheme (52) then requests via a suitable network and interface (58) that a token service provider (60) convert the token collected by the merchant and received from the acquirer (50) back to the associated PAN. The token service provider (60) provides the original PAN to the payment scheme (52) and the payment scheme (52) passes the PAN to the issuer (54) and receives an account number for the payment. The issuer (54) verifies the availability of funds and either authorises or declines the payment and communicates the authorisation or otherwise to the payment scheme (52). In turn, the payment scheme (52) provides authorisation, or declines to provide authorisation, to the acquirer (50) and in turn the authorisation, is provided from the acquirer (50) to the merchant terminal (48). In the event that payment is authorised, the merchant provides the goods and/or services to the user of the DTC (10) and the merchant is assured that he or she will receive funds in return for the goods and/or services provided.

At the time the issuer (54) issues a credit or debit card and creates an account for the account holder, the issuer (54) provides a request via network and interface (58) to a token service provider (60) to generate tokens for the PAN that identifies the issuer and the particular account holder.

In the instance of FIG. 7, since the DTC (10) is operable to adopt one of many different personalities, it effectively is enabled to behave in a similar manner to an electronic wallet without the constraints that are normally encountered when operating an electronic wallet (e-Wallet), such as only being restricted to contactless transactions.

Accordingly, FIG. 7 also details a TSM (62) who receives tokens from the token service provider (60) via the network and interface (58) for the purpose of creating a MMPC (or modified virtual card). The TSM (62) securely distributes MMPC data to an account holder's mobile device. The role of the TSM (62) is to ensure that MMPC data is securely packaged and transferred to the secure element of a mobile device (12). In the example of FIG. 7, the TSM (62) generates a MMPC in the form of a CAP file for installation into, or transfer to the mobile device (12) and for transfer onto the DTC (10). In the example of FIG. 7, CAP files containing MMPC data are transmitted wirelessly to the secure element of a user's mobile device (12).

The user's mobile device (12) may be identified by various pieces of information regarding the device, that when considered in combination, effectively form a “mobile device fingerprint.” The mobile device (12) executes a mobile wallet application and communicates with the DTC (10) preferably by use of a wireless communication protocol such as NFC or Bluetooth.

The user may download a wallet application from a wallet service provider (56) for installation on their mobile device (12) wherein the wallet service provider mobile wallet application allows the user to carry (modified) virtual credit cards, (modified) virtual debit cards or other MMPC information in a digital form on their mobile device (12). In the instance of FIG. 7, the wallet application also includes a module that provides the functionality for the mobile wallet application to communicate and interact with the DTC (10). Once the mobile wallet application has been downloaded from the wallet service provider (56) to the mobile device (12), the TSM (62) can identify the mobile device by the “mobile device fingerprint” and can download MMPCs in the form of CAP files for installation into the mobile wallet application and hence, becomes available for transfer onto the DTC (10) for use in an existing digital transaction network according to the personality encapsulated within the CAP file.

When a user seeks to alter the personality of their DTC (10), they operate the mobile wallet application on their mobile device (12) and may select one of the available credit card personalities according to one of the files that have been previously sent to the DTC (10) and installed on the DTPU of the DTC (10). The mobile device (12) interacts with the DTC (10) by a wireless communication such as NFC or Bluetooth and passes instructions and data to the DTC (10) to adopt the required personality. In an embodiment, the files representing alternative personalities are all active and are ordered in memory according to the personality selected by the user and commanded by the mobile device (12). In an alternative embodiment, all of the files apart from the personality selected by the user are marked as inactive thereby only retaining a single personality active. Once the DTC (10) has adopted the required personality, the DTC (10) may be used to effect transactions in an existing digital transaction network.

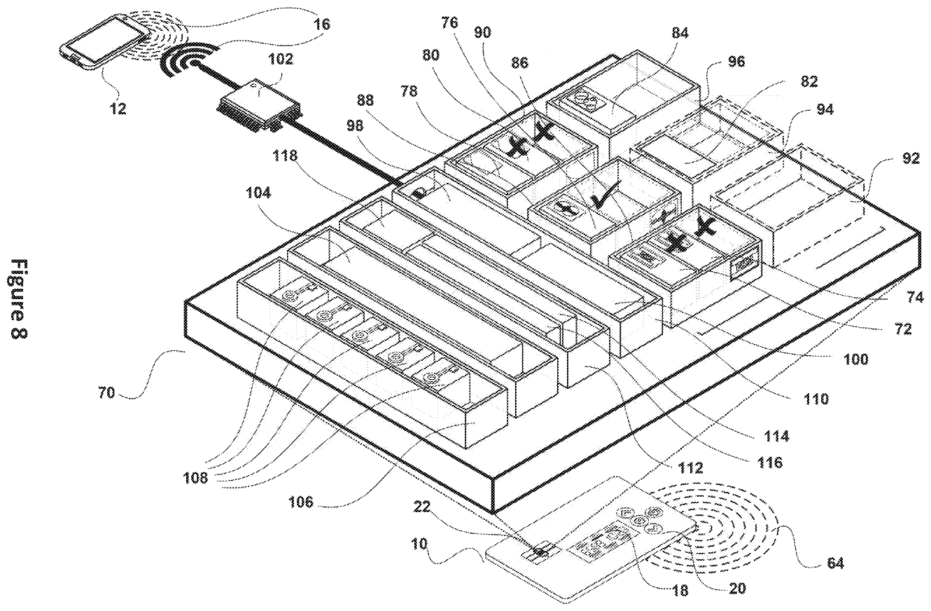

With reference to FIG. 8, a DTC (10) is depicted and the individual components of the EMV chip within the DTC (10) have been expanded and appear above the DTC (10).

In FIG. 8, the DTPU (70) is an EMV chip of the DTC (10) includes a number of applets (72, 74, 76, 78, 80, 82, and 84) and these applets are stored in one of six applet containers (86, 88, 90, 92, 94, and 96) in the secure memory of the EMV chip of the DTC (10). In the example of FIG. 8, the applets (72, 74, 76, 78, 80, 82, and 84) contain data defining one or more digital transaction documents and more particularly, there are applets defining two separate Visa card accounts (72, 74) in Visa applet container (86), an applet defining a MasterCard account (76) in MasterCard applet container (88), applets (78, 80) in applet container (90) defining two “other MMPC profiles”, an applet defining a loyalty card (84) in applet container (96), and available space for applets in two further containers (92, 94) that may define additional digital transaction documents, including applet (82).

All of the applets (72, 74, 76, 78, 80, 82, and 84) reside within the secure memory of an EMV device of the DTC (10) and in the embodiment depicted in FIG. 8, the applets are constructed using Java code or other instruction code and contain the necessary data to define the one or more MMPCs for a particular payment scheme.

In FIG. 8, applets for the two Visa card accounts (72, 74) and the other MMPC profiles (78, 80) are shown with crosses (χ) indicating that those applets, and, hence the MMPCs operating with those applets, are inactive, locked or blocked, and therefore cannot be used for a digital transaction when the DTC (10) is in such state. The MasterCard applet is shown with a tick (V) indicating that applet, and, hence the MMPC operating with that applet, is active, unlocked or unblocked, and therefore can be used for a digital transaction when the DTC (10) is in such state.

Also depicted in FIG. 8, is a Global Platform API (98) and a Global Platform Card Manager (100) depicted in a Global Platform container (110). The Global Platform Standard (GPS) is a standard that enables an open and interoperable infrastructure for smart cards, devices and systems that simplifies development, deployment and management of computer instruction code and the functionality provided by same. The GPS specification has been adopted by most banking institutions for JavaCard based loading of cryptographic data onto smart cards. The standard establishes mechanisms and policies that enable secure channel communication with a credential. Further, the specification represents a standard for managing the infrastructure of a smart card. Management, in this regard, includes installation, removal of applications and additional management tasks on a card. The primary authority for management of card data is the card issuer who generally has full control of the card contents but may grant other institutions access to administer their own software applications. Management is generally achieved by applying cryptographic protocols which authenticate and encipher the relevant processes.

The Global Platform API (98) provides an interface to the functionality provided by the Global Platform Standard and in the embodiment depicted in FIG. 8, the Global Platform API is used to load, configure and select different card personalities for the DTC (10) to effect digital transactions in accordance with that particular selected personality. The Global Platform API (98) is defined as part of the Global Platform Card specification. The Global Platform Card Manager (100) is the central controlling entity in the DTC (10). It includes three separate entities, namely, the Global Platform environment, the issuer's security domain and the card holder verification method services.

In the embodiment depicted in FIG. 8, the DTC (10) operates on a Java platform, and so may be classified as a JavaCard. The DTPU (70) includes a Java container (112), which contains a JavaCard virtual machine (JVM) (114), and a JavaCard runtime environment (JRE) (116). The Java container also includes a JavaCard API (118) for interfacing with applets on the DTC (10).

The DTC (10) also includes a DTC external processor (102) which effects control of the DTC (10). In particular, the DTC external processor (102) communicates with the EMV chip by the Global Platform API (98) and this communication arrangement enables the DTC external processor (102) to update the digital transaction document personalities and the MMPC applications residing in the EMV device.

The EMV device operating system (104) is hardware specific firmware that provides the basic functionality for the EMV device such as secure access to on-card memory storage, authentication and encryption. The operating system (104) includes a sequence of instruction code that resides in non-volatile memory in the EMV device.

The EMV chip of the DTC (10) also contains a “secure vault” (106) of cryptographic keys (108) that are specific to each MMPC stored in the secure memory of the EMV device. The keys (108) are used to generate unique codes during payment transactions that allow merchant terminals to authenticate the particular personality of the DTC (10). The keys (108) include SSD level keys, and may also include ISD level keys depending on the security requirements for calling, activating or otherwise operating with various different applications, applets, GPS commands and other actions requiring security.

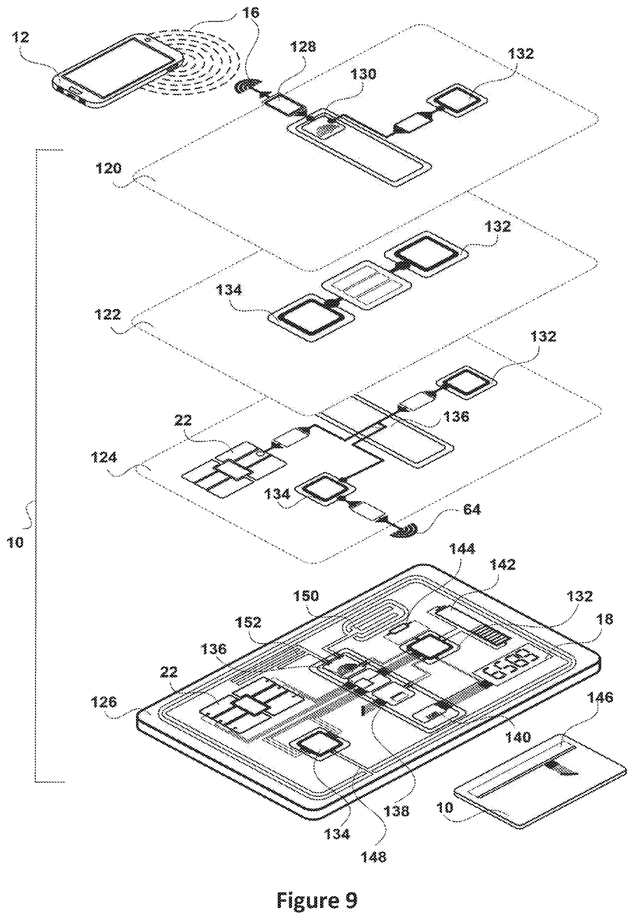

FIG. 9 depicts a DTC subdivided into four separate layers, namely, commands (120), protocols (122), a Message Exchange Layer (124) and a physical (electrical) layer (126). A mobile device (12) is also illustrated in FIG. 9 and communicates data and commands to the DTC (10) via a wireless protocol (16) such as NFC or Bluetooth where those commands and data are received by a transceiver (128). The transceiver (128) converts wireless signals transmitted from the mobile device (12) to signals for reception by a communications module (130) embodied within an Application Specific Integrated Circuit (ASIC). The communications module (130) subsequently transfers commands and data decoded from the transmission of the mobile device (12) to the microcontroller unit (132) and interprets those commands and data. In an embodiment, the proprietary commands transmitted from the mobile device (12) to the DTC by way of the transceiver (128) and ultimately passed through to the microcontroller unit (132), are encrypted to protect the data and security of the DTC.

According to the protocol layer (122), the microcontroller unit (132) communicates according to established protocols with the EMV device (134). In the embodiment of FIG. 9, the microcontroller unit (132) uses a subset of the Global Platform Standard commands to “personalise” the DTPU (EMV) device (134) as required according to commands issued by the mobile device (12). Application Protocol Data Units (APDU's) are used to communicate with the EMV device (134) and the APDU's are also defined in the Global Platform Standard. In order to effect a change of card personality of the DTC, the microcontroller unit (132) communicates with the EMV device (134) using a subset of the personalisation protocol according to the Global Platform Standard.

With reference to the message exchange layer (124), this layer communicates messages between either a merchant terminal and the EMV device (134) or the microcontroller unit (132) and the EMV device (134). The messages for this communication are referred to as Application Protocol Data Units (APDU's) which are defined by standards.

There are two primary categories for APDU's, namely, command APDU's and response APDU's. Effectively, the APDU commands are the messaging protocol for communicating with the EMV device (134). The message exchange layer (124) also depicts the external contacts (22) of an EMV device (134). Further, the message exchange layer (124) also depicts an exchange (136) which allows communication between the microcontroller unit (132) and the EMV device (134) or alternatively, communication that may occur between the EMV contacts (22) and the EMV device (134). As will be appreciated by skilled readers, communication between the EMV device contacts (22) and the EMV device (134) will occur when the DTC is used in a merchant terminal a “dipping mode” wherein the DTC is inserted into the merchant terminal and contact within the merchant terminal directly engage with the EMV contacts (22). In this instance, communication between the EMV contacts (22) and the EMV device (134) must be effected without any interference in the communication attempted by another device such as the microcontroller unit (132). However, in instances where communication between the microcontroller unit (132) and the EMV device (134) is required, the exchange (136) effectively disconnects the communication path between the EMV contacts (22) and the EMV device (134) such that communication may be effected between the microcontroller unit (132) and the EMV device (134) without interference from any device making contact with the EMV contacts (22). As depicted in FIG. 9, communication between the microcontroller unit (132) and the EMV contacts (22) and the EMV device (134) is effected by APDU's in the embodiment of FIG. 9, an APDU contains a mandatory four bite header defining the command and from zero to sixty-four kb of data. A response APDU may be sent by the EMV device (134) back to a merchant terminal or the microcontroller unit (132) and contains from zero to sixty-four kb of data and two mandatory status bites.

With reference to the physical (electrical) layer (126), various additional components of the DTC are depicted including a dynamic magnetic stripe module, a display driver (140) and a corresponding display screen (18), a battery (142) and a time device (144), which may be a real-time clock or other time measuring device. In this embodiment, the time device is a crystal that provides an oscillator that is used to determine the clock signal for all of the electronic devices on board the DTC.

Also depicted in FIG. 9, is a diagrammatic representation of the rear side of a DTC (10) including a dynamic magnetic stripe (146). Additional elements are also depicted in the physical (electrical) layer (126) including an EMV device antenna (148), an NFC antenna (150) connected to the communications module (130) and a Bluetooth antenna (152) also connected to the communication module (130).

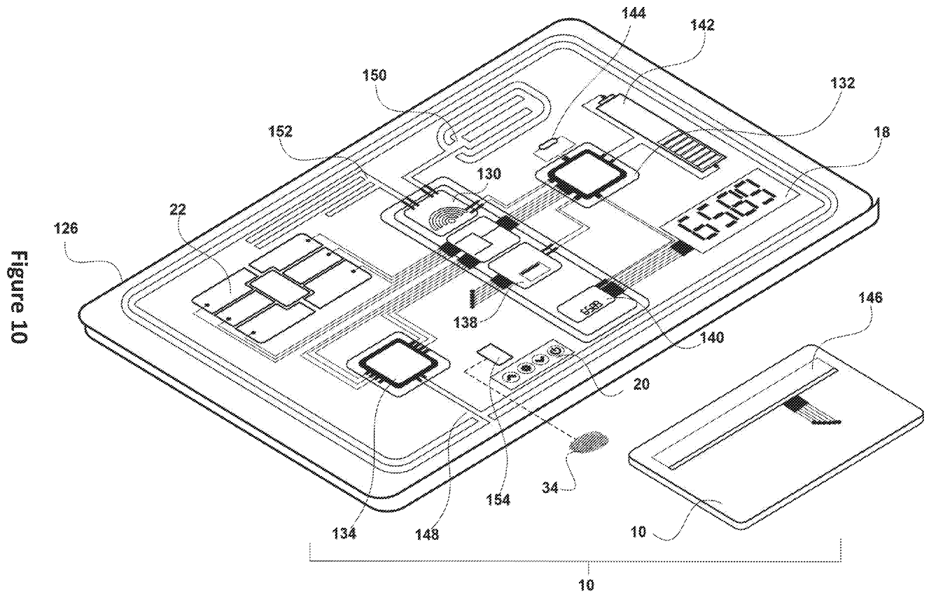

With reference to FIG. 10, an enlarged version of the Physical (Electrical) Layer (126) of FIG. 9 is detailed for more clearly illustrating the individual elements of the Physical (Electrical) Layer. Also shown on the Physical (Electrical) Layer (126) of FIG. 10 (not shown in FIG. 9) is a device and circuitry for a biometric reader (154). In the present embodiment, the biometric reader (154) is configured for detecting and matching a fingerprint (34) of a DTC user. It will be understood by the skilled reader that biometric readers may be configured for detecting and matching biometrics different from a fingerprint, and may include iris scanning, ear scanning, facial recognition and other suitable biometric indicators. Further shown on the Physical (Electrical) Layer (126) of FIG. 10 (not shown in FIG. 9) are buttons (20) and button circuitry. The buttons configured for operating the card when pressed by a user.

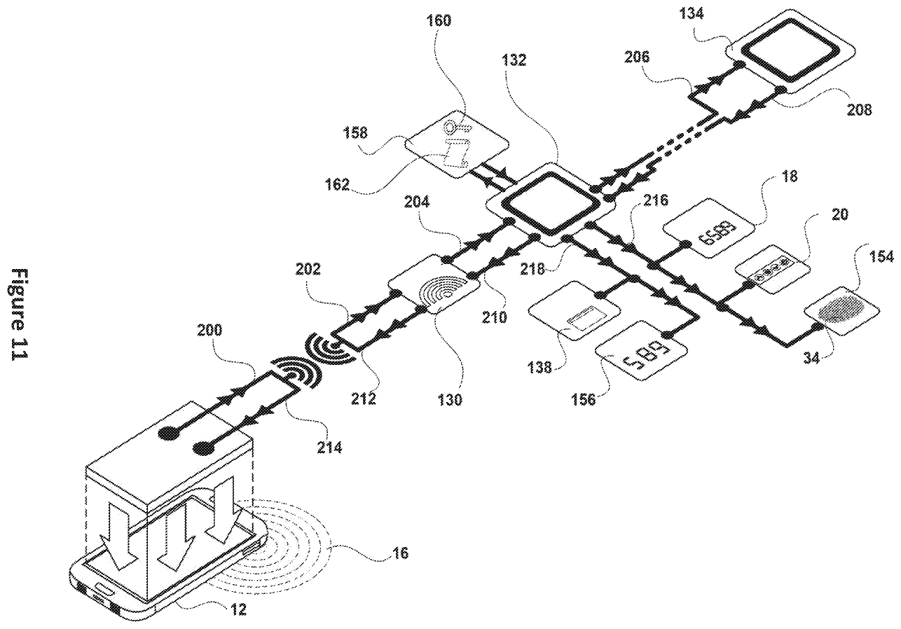

FIG. 11 details the data flow between devices as a result of the issuance of a command from a user's mobile device and receipt of data from the DTC to the user's mobile device.

FIG. 11 provides a diagrammatic representation of a DTC (10) according to an embodiment of the invention and is similar to the diagrammatic representation of the FIG. 10 with the addition of a mobile device (12) and overlaid over the diagrammatic representation is a series of arrowed line segments depicting the flow of data as it occurs to and from the mobile device (12) and individual elements contained within the DTC as depicted in FIG. 10.

With reference to FIG. 11, in the instance of a user issuing a command from their mobile device (12) to the DTC, the command and/or data associated with same, is communicated along data flow 200 and in the example depicted in FIG. 11, is communicated wirelessly to the DTC either by NFC or Bluetooth wireless capability. The DTC receives the command issued by the mobile device (12) and indicated by the data flow 200 and receives the command and/or data as depicted by data flow 202 at the communications module (130). The communications module (130) having converted the command and/or data received 202, passes a signal to the microcontroller unit (132) along data flow path 204 for processing by the microcontroller unit (132).

In the event that the data received by the microcontroller unit (132) depicted by data flow 204 represents a command requiring the microcontroller unit (132) to communicate with the DTPU (EMV) device (134), then the microcontroller unit (132) transmits a signal to the EMV device (134) as shown by data flow 206.

In the instance of the command issued by the mobile device (12) to effect a change in personality of the DTC, the EMV device (134) upon receiving and altering the EMV device (134) personality, in accordance with data provided as depicted by data flow 206, the EMV device (134) provides a return signal as depicted by data flow 208 to the microcontroller unit (132) confirming that the change in personality of the EMV device (134) has been effected.

At this stage, the microcontroller unit (132) generates and transmits a signal to the communications module (130) as depicted by data flow 210, said signal being a signal confirming the alteration of the EMV device (134) personality according to the instruction initiated at the user's mobile device (12). The communications module (130) upon receiving the signal 210 converts the signal for wireless transmission to the mobile device (12), the wireless signal depicted as data flow 212.

The user's mobile device (12) receives the wirelessly transmitted signal 212 and upon conversion of that wireless signal, the user's mobile device (12) internally processes the signal 214 and provides a visual indication to the user on the user interface of the mobile device (12) confirming the requested change in personality of the EMV device (134) such that the DTC will now operate according to the personality of the card requested by the user.

Also depicted in FIG. 11 is a data flow from the microcontroller unit (132) to some other components of the DTC (10), including the display (18), the buttons (20), and the biometric reader on the DTC (154). Another data flow 218 shows data communicated between the microcontroller unit (132) and the magnetic stripe circuitry (138) and a dynamic CVV display (156). It will be understood by a skilled reader that data flows 216 and 218 may be in a direction opposite that shown by the arrows on the data flow lines, such that communication occurs to and from each component (18, 20, 154, 138, and 156) and the microcontroller unit (132).

Further depicted in FIG. 11 is secure memory (158), into which can be stored one or more keys (160), and one more scripts (162). The keys and scripts may be used for operating applications, applets, GP commands and the like, which have security requirements, and wherein the keys and/or scripts are used to provide authentication and/or authorization to access a required operation.

As will be appreciated, when seeking to develop a DTC that is operable with an existing digital transaction network infrastructure, it is preferable that the DTC is operable to communicate with devices already present within an existing network infrastructure according to the communication capabilities and protocols recognised and established for devices in that network. In this regard, as previously detailed in other Figures, merchant terminals, and other devices such as ATMs, that presently exist in established digital transaction networks provide communication facilities between credit cards and devices according to the standards developed for NFC, physical contact with the EMV device contacts of a credit card and by swiping and reading the magnetic stripe on the rear face of a credit card. Accordingly, when seeking to provide a DTC operable with an existing transaction network yet including additional functionality, it is preferable to provide a DTC that is operable with an existing digital transaction network according to the current protocol standards and interfaces. As a result, it is preferred to provide a DTC that also has the capability to be used with a merchant terminal that relies upon the use of the magnetic stripe and as a result, in an embodiment of the invention, the DTC is provided with a dynamic magnetic stripe that is controlled by the magnetic stripe component (138).

In this regard, since the DTC according to an embodiment of the invention is operable to adopt any one of a number of personalities that may be selected and activated by a user, the magnetic stripe on the rear face of the DTC requires a magnetic stripe that may be configured according to the personality of the DTC at any particular point in time. Accordingly, the microcontroller unit (132) is provided with a data connection with the magnetic stripe component (138) and is operable to configure the magnetic stripe on the rear face of the DTC such that it accords with the magnetic stripe relevant to the personality of the DTC at any particular point in time.

Further, since the DTC according to the embodiment of the invention depicted in the Figures includes a display, the microcontroller unit (132) is provided with direct connection with the display module (140) which drives the display (18) which can be used to provide information to a user of the DTC independently of the user's mobile device (12).

A DTC according to an embodiment of the invention depicted in the Figures, provides a user with the ability to combine various logical cards (also referred to as card personalities or MMPC profiles) onto a single physical (DTC) card with the ability to select and activate any one of the various personalities that are stored on the DTC at any particular point in time for the purpose of effecting a transaction. Further, according to the embodiment depicted in the Figures, the DTC is operable according to all of the available protocols and interfaces that presently exist in established digital transaction networks and therefore, a DTC according to an embodiment described in the present specification can be used with existing digital transaction networks anywhere in the world. This is particularly important for countries in which the installed digital transaction network includes devices that have yet to be upgraded to communicate with DTCs according to NFC capabilities and may be restricted to either direct physical contact with the EMV device contact plate or use of the magnetic stripe which may be prevalent in countries that are considered to fall within the category of “developing nations.” Further, it will also be appreciated by skilled persons, that even in “developed nations” wherein the existing digital transaction network infrastructure includes many terminals that have NFC communication capabilities, many consumers have not yet elected to adopt the E-Wallet services offered by many commercial operators since their mobile phone or smartphone device does not have NFC communication capabilities and in order to use the presently offered E-Wallet commercial services, it is necessary to implement those services on a smartphone that includes NFC communication facilities. Of course, a DTC according to an embodiment described in the present specification may communicate with any device that incorporates a Bluetooth communications facility which includes many older generation smartphones and hence, according to an embodiment of the invention, a user may select and activate a particular personality for a DTC by selecting and activating that personality on their smartphone equipped solely with Bluetooth communication facilities and communicate that instruction to a DTC according to established Bluetooth communication protocols and having selected and activated a particular personality for their DTC using Bluetooth communication facilities, the DTC may be used to effect a transaction with an existing digital transaction network according to any of the currently available protocols and interfaces including magnetic stripe and physical contact with the EMV device contact plate.

The reference to any prior art in this specification is not, and should not be taken as, an acknowledgement or any suggestion that the prior art forms part of the common general knowledge.

Throughout this specification and claims which follow, unless the context requires otherwise, the word “comprise”, and variations such as “comprises” and “comprising”, will be understood to mean the inclusion of a stated integer or step, or group of integers or steps, but not the exclusion of any other integer or step or group of integers or steps.

It will be appreciated by persons skilled in the relevant field of technology that numerous variations and/or modifications may be made to the invention as detailed in the embodiments without departing from the spirit or scope of the invention as broadly described. The present embodiments are therefore to be considered in all aspects as illustrative and not restrictive.

What is claimed is:

1. A digital transaction system operable to perform at least one digital transaction with at least one digital transaction device, the digital transaction system comprising:
a Digital Transaction Card (DTC) comprising:
a Digital Transaction Processing Unit (DTPU), the DTPU including a software module including instruction code which, when executed, causes the DTPU to receive and implement instructions in accordance with a standard command protocol (“standard commands”);
a DTC external processor; and a DTC transceiver,
in which:
the DTPU software module is operable to receive a plurality of standard commands issued by the DTC external processor responsive to user selection of a desired DTC personality, thus causing the DTPU to adopt the user selected personality; and
upon completion of execution of the plurality of standard commands, the DTC adopts the user selected personality as the personality of the DTC.

2. A digital transaction system according to claim 1, in which DTC personalities which are available for user selection are stored in an external third-party system.

3. A digital transaction system according to claim 2, the digital transaction system further comprising:
a Data Assistance Device (DAD) having access to data in the third-party system pertaining to a plurality of DTC personalities, the DAD comprising:
DAD user interface;
a DAD processor; and
a DAD transceiver,
in which:
the external third-party system and the DAD are operable to transfer data from the third-party system to the DAD;
the DAD and the DTC are operable to transfer data from the DAD to the DTC; and
the DTPU software module is operable to receive the plurality of standard commands issued by the DTC external processor responsive to user selection of the desired DTC personality by using the DAD user interface.

4. A digital transaction system according to claim 1 wherein the DTPU further comprises a DTC user interface, in which:
the DTC external processor has:
received data pertaining to a plurality of separate DTC personalities; and
stored the plurality of personalities in DTPU storage memory; and
the DTPU software module is operable to receive a plurality of standard commands issued by the DTC external processor responsive to user selection of a desired personality using the DTC user interface, causing the DTPU to activate the user selected personality; and
upon completion of execution of the plurality of standard commands, the DTC adopts the user selected personality as the personality of the DTC.

5. A digital transaction system according to claim 4, further comprising a Data Assistance Device (DAD) the DAD comprising:
a DAD user interface;
a DAD processor; and
a DAD transceiver,
in which:
the DAD is operable to receive data from an external third party;
the DTC and DAD are enabled to transfer data from the DAD to the DTC; and
the transfer of data from the DAD to the DTC is effected by the DAD processor and the DTC external processor and respective transceivers.

6. The digital transaction system according claim 1, in which the standard command protocol is the Global Platform Standard (GPS).

7. The digital transaction system according to claim 1, in which each personality is represented by a Modified Mobile Payment Card (MMPC).

8. A method for operating a digital transaction system, the digital transaction system operable to perform at least one digital transaction with at least one digital transaction device, the digital transaction system comprising:
a Digital Transaction Card (DTC) comprising;
a Digital Transaction Processing Unit (DTPU), the DTPU comprising a software module including instruction code which, when executed, causes the DTPU to receive and implement instructions in accordance with a standard command protocol (“standard commands”);
a DTC external processor; and a DTC transceiver,
the method comprising:
issuance of a plurality of standard commands from the DTC external processor to the DTPU responsive to user selection of a desired DTC personality;
the plurality of standard commands causing the DTPU to activate the user selected personality; and
the DTC thereby adopting the user selected DTC personality and being operable for use in a digital transaction network to effect transactions as the user selected DTC personality.

9. A method for operating a digital transaction system according to claim 8, in which DTC personalities which are available for user selection are stored in an external third-party system.

10. A method for operating a digital transaction system according to claim 9, the digital transaction system further comprising:
a Data Assistance Device (DAD) having access to data in the third-party system pertaining to a plurality of DTC personalities, the DAD comprising:
a DAD user interface;
a DAD processor; and
a DAD transceiver,
in which:
the external third-party system and the DAD are operable to transfer data from the third-party system to the DAD; and
the DAD and DTC are operable to transfer data from the DAD to the DTC, the method further including:
issuance of a plurality of standard commands from the DTC external processor to the DTPU responsive to user selection of the desired DTC personality by using the DAD user interface.

11. A method for operating a digital transaction system according to claim 8, wherein the DTPU further comprises:
a DTC user interface; and the method further comprises:
issuance of a first plurality of standard commands to the DTPU to store data pertaining to a plurality of separate DTC personalities in DTPU storage memory, and
issuance of a second plurality of standard commands from the DTC external processor to the DTPU responsive to user selection of a desired DTC personality using the DTC user interface, the second plurality of standard commands causing the DTPU to activate the user selected personality, the DTC thereby adopting the user selected DTC personality and being operable for use in a digital transaction network to effect transactions as the user selected DTC personality.

12. A method for operating a digital transaction system according to claim 11, the system further comprising:
a Data Assistance Device (DAD), comprising:
a DAD user interface;
a DAD processor; and
a DAD transceiver,
in which method:
the DAD is operable to receive data from an external third party;
the DTC and DAD are enabled to transfer data from the DAD to the DTC; and
the transfer of data from the DAD to the DTC is effected by the DAD processor and the DTC external processor and respective transceivers.

13. A method according to claim 8 in which a user receives a Digital Transaction Card (DTC) from an issuing authority.

14. A method according to claim 8 in which an issuing authority issues a Digital Transaction Card (DTC).

15. A method according to claim 8 in which an issuing authority issues operating code, comprising software and/or firmware, for a Data Assistance Device (DAD) and/or for a Digital Transaction Card (DTC).

16. The method according claim 8, in which the standard command protocol is the Global Platform Standard (GPS).

17. The method according to claim 8, in which each personality is represented by a Modified Mobile Payment Card (MMPC).

18. A Digital Transaction Card (DTC) for use in a digital transaction system, the DTC comprising:
a Digital Transaction Processing Unit (DTPU), the DTPU including a software module having instruction code which, when executed, causes the DTPU operating system to receive and implement commands according with a standard command structure (“standard commands”);
a DTC external processor;
a DTC transceiver; and
a DTC user interface,
in which:
the DTC external processor has received data pertaining to a plurality of separate DTC personalities and stored the plurality of personalities in DTPU storage memory; and;
the DTPU software module is operable to receive a plurality of standard commands issued by the DTC external processor responsive to user selection of a desired personality using the DTC user interface, causing the DTPU to activate the user selected personality; and
upon completion of execution of the plurality of standard commands, the DTC adopts the user selected personality defined for the DTC.

19. A DTC according to claim 18, the DTC operable to receive data from a Data Assistance Device (DAD), the DAD comprising:
a DAD user interface;
a DAD processor; and
a DAD transceiver,
in which:
the DAD is operable to receive data from an external third party;
the DTC and DAD are enabled to transfer data from the DAD to the DTC; and
the transfer of data from the DAD to the DTC is effected by the DAD processor and the DTC external processor and respective transceivers.
